(19) United States
(12) Patent Application Publication
(10) Pub. No.: US 2025/0094961 A1
(43) Pub. Date: Mar. 20, 2025

(54) SYSTEMS AND METHODS FOR GESTURE-BASED AUTHENTICATION

(71) Applicant: PLUME DESIGN, INC., Palo Alto, CA (US)

(72) Inventors: Rok VIDMAR, Ljubljana (SI); Gašper ŠTUKELJ, Maribor (SI); Kiran EDARA, Cupertino, CA (US)

(21) Appl. No.: 18/830,770

(22) Filed: Sep. 11, 2024

Related U.S. Application Data
(60) Provisional application No. 63/582,572, filed on Sep. 14, 2023.
(60) Provisional application No. 63/582,578, filed on Sep. 14, 2023.

(51) Int. Cl. G06Q 20/32; G06F 3/01; G06Q 20/40

(52) U.S. Cl. CPC G06Q 20/3278; G06F 3/017; G06Q 20/40145

(57) ABSTRACT

In some implementations, a disclosed method may include receiving, from a wearable, data representative of a gesture executed by a wearer of the wearable, and recognizing, based on the data representative of the gesture, the gesture executed by the wearer. The disclosed method may also include identifying, based on the data representative of the gesture, the wearer via a machine learning model trained to identify biomechanical characteristics of wearers based on gesture data. The disclosed method may also include executing, based on the gesture executed by the wearer and identifying of the wearer, a security action directed to a secured device. Various other systems, methods, and computer-readable media are also disclosed.

### CROSS REFERENCES TO RELATED APPLICATIONS

This application claims the benefit of priority from U.S. Provisional Application No. 63/582,572, titled “Systems And Methods For Gesture-Based Authentication,” filed Sep. 14, 2023, and U.S. Provisional Application No. 63/582,578, titled “Systems And Methods For Authenticating Wearers Of Wearables Via Biomechanical Gestures,” filed Sep. 14, 2023, the disclosures of each of which are incorporated, in their entirety, by reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for gesture-based authentication.

FIG. 2 is a block diagram of an example system that implements a system for gesture-based authentication.

FIG. 3 is a flow diagram of an example method for gesture-based authentication.

FIG. 4 illustrates example gestures that a wearer of a wearable device may execute as part of a gesture-based authentication process.

FIG. 5 is a block diagram of an example system for authenticating wearers of wearables via biomechanical gestures.

FIG. 6 is a block diagram of an example system that implements a system for authenticating wearers of wearables via biomechanical gestures.

FIG. 7 is a flow diagram of an example method for authenticating wearers of wearables via biomechanical gestures.

FIG. 8 shows a perspective view of an example smart ring device that may be used in connection with some of the systems and methods disclosed herein.

FIG. 9 illustrates example gestures that a wearer of a wearable device may execute as part of a gesture-based authentication process.

FIG. 10 shows a perspective view of an execution of a structured continuous gesture in accordance with some examples disclosed herein.

FIG. 11 illustrates example structured continuous gestures in accordance with some examples disclosed herein.

FIG. 12 and FIG. 13 illustrate tactile feedback provided in concert with structured continuous gestures for authenticating wearers of wearables via biomechanical gestures.

FIG. 14 is a block diagram that illustrates authentication of a wearer of a wearable via an authentication interface in accordance with some examples disclosed herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The recent explosion of low-cost and feature rich smart home devices has raised new and unresolved issues with security of such connected devices. Exiting user authentication methodologies for connected devices (e.g., wearable devices, Internet of Things (IoT) devices, smart home devices, etc.) generally rely on conventional passwords or identification methodologies, which can be cumbersome and insecure. Hence, the present disclosure identifies and addresses a need for new secure authentication methodologies that can be applied to a wide variety of connected devices.

The present disclosure is generally directed to systems and methods for gesture-based authentication via wearable devices. As will be described in greater detail below, embodiments of the present disclosure may identify a wearer of a wearable device, recognize a gesture executed by the wearer, and may execute a security action directed to a secured device.

As an example, an embodiment may receive data from a wearable device that represents a physical gesture executed by the wearer of the device. This gesture input data may be generated by various sensors embedded in the wearable device and may describe one or more movements performed by the wearer. The embodiment may then recognize the executed gesture based on the received data, such as by comparing the received data to pre-existing patterns or using machine learning techniques to classify the gesture. These identifying gestures can be employed as standalone authentication factors or as part of a multi-factor authentication system (e.g., two-factor authentication, n-factor authentication, etc.).

An embodiment may also identify the wearer based on the data representative of the gesture. This may be done using a machine learning model that has been trained to identify unique biomechanical characteristics of wearers based on gesture data. Biomechanical characteristics may include distinct features of how an individual moves or performs physical tasks. These features can be specific and unique enough to differentiate between individuals, essentially acting as a kind of biometric identification. In other words, the models may vary between users, even if the same gesture is performed (for example, making the letters “A”, “B”, “C” in sequence and shape). The authentication gesture can either be a combination of simple, smaller gestures performed in a specific sequence, or be treated as a singular, continuous movement.

Based on the recognition of the gesture and the identification of the wearer, an embodiment may execute a security action directed towards a secured device. This could mean that access to the secured device is granted or denied, or it could involve other security protocols depending on the nature of the secured device and the implemented security measures. Therefore, embodiments of the present disclosure may enable gesture-based user identification and secure control of secured devices.

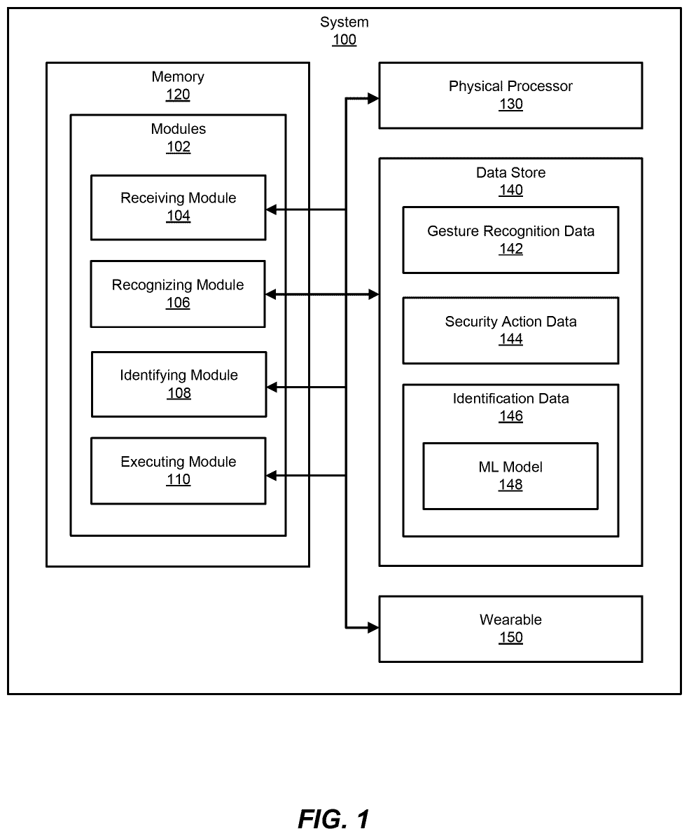

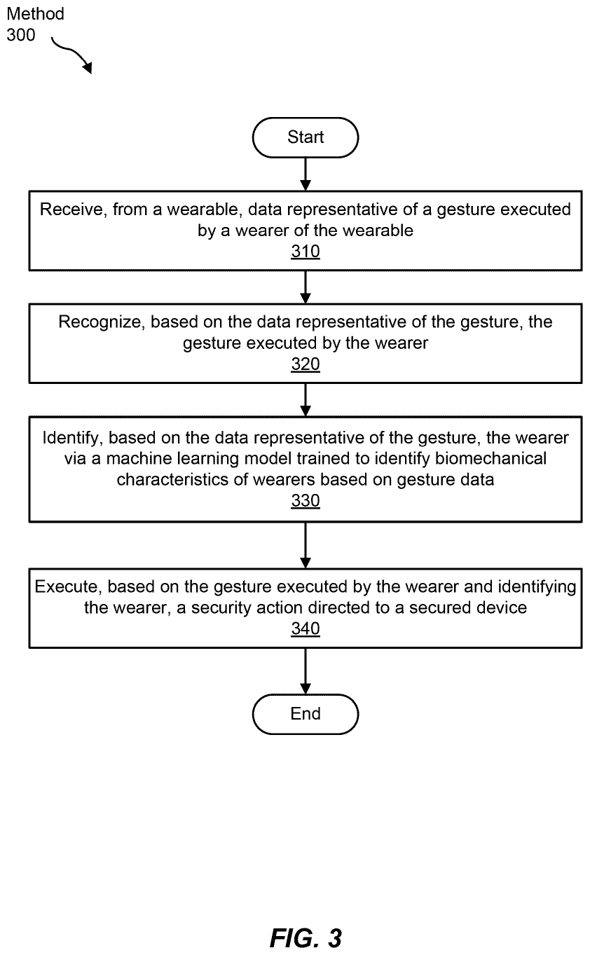

The following will provide, with reference to FIGS. 1-2 and 4, detailed descriptions of systems for contextual gesture-based control of connected devices. Detailed descriptions of corresponding computer-implemented methods will also be provided in connection with FIG. 3.

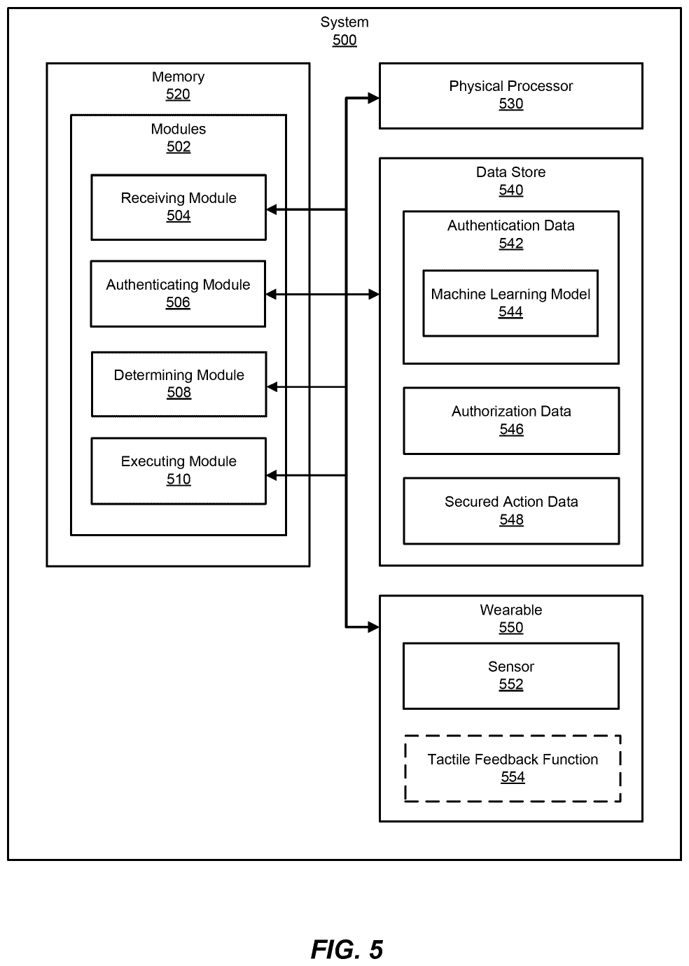

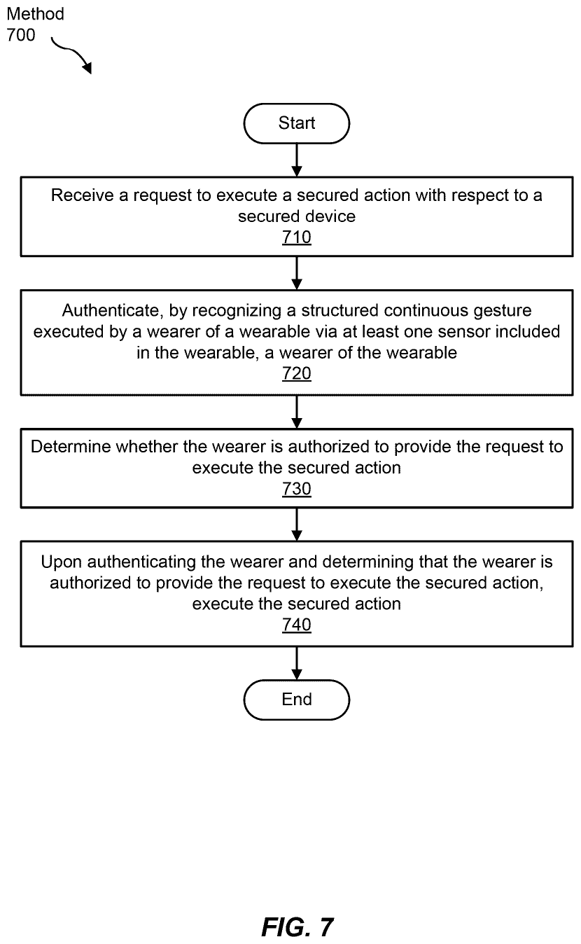

The following will also provide, with reference to FIGS. 5-6 and 8-14, detailed descriptions of systems for authenticating wearers of wearables via biomechanical gestures. Detailed descriptions of corresponding computer-implemented methods will also be provided in connection with FIG. 7.

FIG. 1 is a block diagram of an example system 100 for gesture-based authentication via wearable devices. As illustrated in this figure, example system 100 may include one or more modules 102 for performing one or more tasks. As will be explained in greater detail below, modules 102 may include a receiving module 104 that may receive, from a wearable, data representative of a gesture executed by a wearer of the wearable. Additionally, example system 100 may also include a recognizing module 106 that may recognize, based on the data representative of the gesture, the gesture executed by the wearer.

As also shown in FIG. 1, example system 100 may also include an identifying module 108 that identifies, based on the data representative of the gesture, the wearer via a machine learning model trained to identify biomechanical characteristics of wearers based on gesture data. Furthermore, example system 100 may also include an executing module 110 that executes, based on the gesture executed by the wearer and identifying the wearer, a security action directed to a secured device.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate contextual gesture-based control of connected devices. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 1, example system 100 may also include one or more stores of data, such as data store 140. Data store 140 may represent portions of a single data store or computing device or a plurality of data stores or computing devices. In some embodiments, data store 140 may be a logical container for data and may be implemented in various forms (e.g., a database, a file, file system, a data structure, etc.). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

In at least one example, data store 140 may include gesture recognition data 142 that may include information associated with recognizing gestures executed by wearers of wearable devices. For example, gesture recognition data 142 may include data associated with gestures, gesture patterns, data patterns representative of gestures, one or more mathematical models for recognizing gestures based on received data, and so forth.

Additionally, as shown in FIG. 1, data store 140 may also include security action data 144 that may include data for executing security actions related to connected devices, such as one or more application programming interfaces (APIs) for providing commands to and/or receiving data from one or more connected devices, one or more configurations of a set of connected devices, one or more programs for executing one or more security actions, and so forth. By way of illustration, in some examples, security action data 144 may include data representative of a configuration of, and/or one or more methods of interacting electronically and/or programmatically with, one or more smart home devices.

In some examples, data store 140 may also include identification data 146 that may include data related to and/or associated with identifying a wearer of a wearable (e.g., wearable 150) and that may be accessed and/or analyzed by one or more of modules 102 (e.g., identifying module 108) to identify a wearer (e.g., at a time of execution of the gesture). As will be described in greater detail below, this identification data may include any suitable present and/or historic data associated with the wearer including, without limitation, a pre-recorded biometric profile of the wearer, gesture data, unique gesture data, location tracking data associated with the wearer, habit data associated with the wearer, time data, temperature data, media data, media consumption data, smart home device data, and so forth.

In some examples, identification data 146 may include a machine learning model 148 (shown in FIG. 1 as “ML Model 148”). Machine learning model 148 may include a machine learning model trained to identify biomechanical characteristics of wearers based on input data (e.g., gesture data). In some examples, a machine learning model may include any a computational model that has been trained on data to recognize and distinguish unique attributes of individual users.

Machine learning models may leverage machine learning algorithms to learn from gesture data, which could include motion sensor data, accelerometer data, gyroscope data, magnetometer data, or other types of sensor data gathered by a wearable device as the wearer executes various movements or gestures. The characteristics identified could include, but are not limited to, specific patterns of movement, pace, strength, flexibility, or idiosyncrasies in how certain gestures are performed.

The model, through a process of training and validation with large volumes of gesture data, may learn to create a mapping between input gesture data and specific wearer characteristics. This may enable the model to take in new, unseen gesture data and predict or identify specific wearer characteristics based on its training. The identification of wearer's characteristics could be used for various applications, such as user authentication, personalized user experience, health monitoring, and more.

Machine learning model 148 may include or represent any suitable type or form of machine learning model. For example, machine learning model 148 may include, without limitation, a supervised learning model (e.g., a linear regression model, a logistical regression model, a decision tree, a random forest, a support vector machine, a naive Bayes classifier, a k-nearest neighbors model, etc.), an unsupervised learning model (e.g., a k-means clustering algorithm, a hierarchical clustering algorithm, a density-based clustering algorithm, a principal component analysis method, etc.), a neural network (e.g., an artificial neural network (ANN), a convolutional neural network (CNN), a recurrent neural network, a generative adversarial network (GAN), an autoencoder, etc.) and so forth.

As is further shown in FIG. 1, example system 100 may also include a wearable 150. In some examples, a “wearable” or “wearable device” generally includes devices designed and/or intended to be worn by a wearer and/or integrated into clothing. These devices may have the ability to connect to the internet, sync with other devices (e.g., mobile phones, personal computers, tablet computers, etc.) and provide a variety of features including but not limited to tracking physical activity (e.g., steps, heart rate, calories burned, etc.), monitoring biometric information (e.g., blood pressure, blood glucose levels, sleep quality, etc.), providing notifications (e.g., voice calls, emails, text messages, reminders, etc.), supporting navigation (e.g., via positioning systems, Wi-Fi, triangulation, etc.), making contactless payments, voice control, and/or gesture recognition.

In some examples, a wearable (e.g., wearable 150) may include a smart ring. Smart rings are a specific type of wearable technology that may be worn on a wearer's finger, similar to a traditional ring. They can be designed to provide various functionalities like those mentioned above and are often focused on discrete or minimalist design to maintain the outward style aspect of a ring while adding smart capabilities. Some may even include bio-sensing features such as measuring stress, body temperature, or providing an electrocardiogram (ECG). These features can vary greatly depending on the particular make and model of the smart ring, and hence this disclosure is not limited to any particular wearable device.

Wearable devices may include a variety of sensors depending on their specific design and function. These sensors may include an accelerometer, a gyroscope, a magnetometer, a heart rate sensor, a photoplethysmography sensor, a GPS sensor, a barometer, an ambient light sensor, a skin temperature sensor, a bioimpedance sensor, a galvanic skin response sensor, one or more capacitive sensors, and so forth. This list is illustrative and non-exhaustive, as specific combinations and types of sensors can vary widely based on the particular application and design of the wearable device.

In additional or alternative examples, a wearable (e.g., wearable 150) may include any device capable of (1) gathering data representative of a gesture executed by a wearer of the wearable, and (2) transmitting that data to one or more of modules 102 (e.g., receiving module 104), such as a smart phone, an outside-in tracking system, an inside-out tracking system, a computer vision tracking system, and so forth.

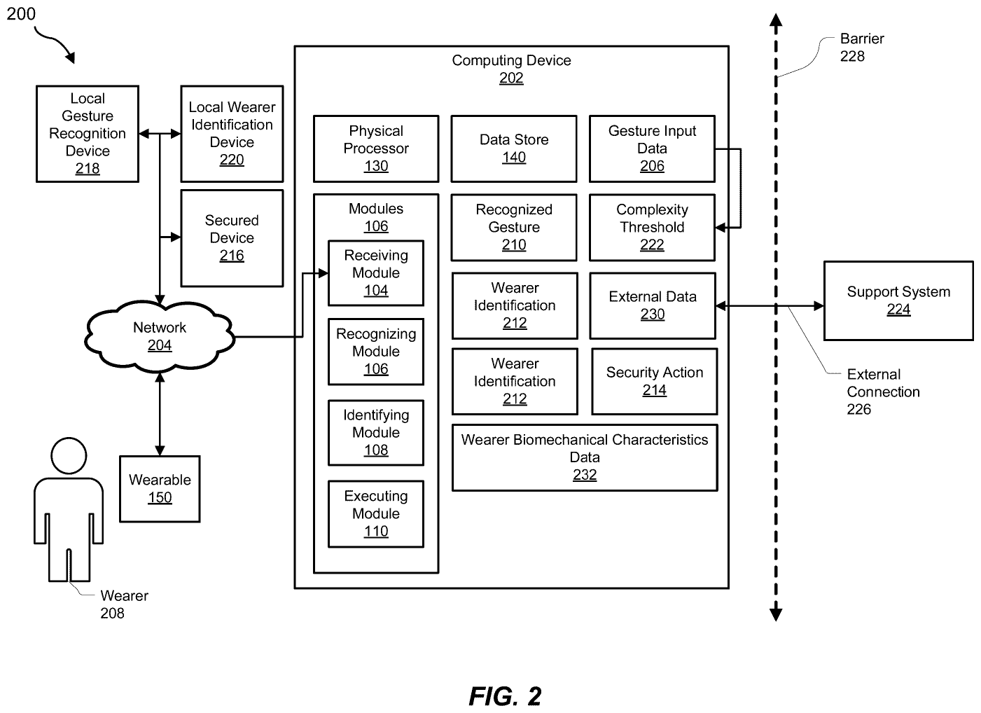

Example system 100 in FIG. 1 may be implemented in a variety of ways. For example, all or a portion of example system 100 may represent portions of an example system 200 (“system 200”) in FIG. 2. FIG. 2 is a block diagram of an example system 200 that implements a system for contextual gesture-based control of connected devices. As shown in FIG. 2, system 200 may include a computing device 202 in communication with wearable 150 via network 204. In at least one example, computing device 202 may be programmed with one or more of modules 102.

In at least one embodiment, one or more modules 102 from FIG. 1 may, when executed by computing device 202, cause computing device 202 to perform one or more operations to enable contextual gesture-based control of connected devices. For example, as will be described in greater detail below, receiving module 104 may cause computing device 202 to receive, from a wearable (e.g., wearable 150), data representative of a gesture (e.g., gesture input data 206) executed by a wearer (e.g., wearer 208) of the wearable.

Additionally, recognizing module 106 may cause computing device 202 to recognize, based on the data representative of the gesture, the gesture executed by the wearer (e.g., recognized gesture 210). Furthermore, identifying module 108 may cause computing device 202 to identify, based on the data representative of the gesture, the wearer via a machine learning model trained to identify biomechanical characteristics of wearers based on gesture data (e.g., machine learning model 148). Moreover, executing module 110 may cause computing device 202 to execute, based on the gesture executed by the wearer (e.g., recognized gesture 210) and identifying the wearer (e.g., identification 212), a security action (e.g., security action 214) directed to a secured device (e.g., secured device 216).

In some additional examples, one or more of modules 102 (e.g., recognizing module 106, identifying module 108, etc.) may perform operations locally, via a local gesture recognition device (e.g., local gesture recognition device 218) and/or a local wearer identification device (e.g., local wearer identification device 220) included in network 204. In additional or alternative examples, one or more of modules 102 (e.g., recognizing module 106) may determine, based on the data representative of the gesture executed by the wearer of the wearable, that the gesture exceeds a predetermined degree of gesture complexity (e.g., complexity threshold 222). In such examples, the one or more modules 102 (e.g., recognizing module 106) may (1) transmit the data representative of the gesture to an external support system (e.g., external support system 224) that is external to the network (e.g., via external connection 226 through barrier 228). Hence, in some examples, one or more of modules 102 may receive, from the external support system (e.g., external support system 224), external data (e.g., external data 230) that may include data representative of a recognized gesture and/or data representative of an identified wearer. In some examples, one or more of modules 102 (e.g., identifying module 108 and/or executing module 110) may use external data received from the external support system in one or more operations (e.g., recognizing the gesture executed by wearer 208 and/or identifying wearer 208).

Additionally, in some examples, one or more of modules 102 (e.g., executing module 110) may gather data representative of biomechanical characteristics of the wearer (e.g., biomechanical characteristics data 232), and may train the machine learning model to identify the wearer based on the data representative of biomechanical characteristics of the wearer.

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

Network 204 generally represents any medium or architecture capable of facilitating communication and/or data transfer between computing device 202 and one or more other devices. Examples of network 204 include, without limitation, an intranet, a WAN, a LAN, a Personal Area Network (PAN), the Internet, Power Line Communications (PLC), a cellular network (e.g., a Global System for Mobile Communications (GSM) network, a code-division multiple access (CDMA) network, a Long-Term Evolution (LTE) network, etc.), universal serial bus (USB) connections, and the like. Network 204 may facilitate communication or data transfer using wireless or wired connections. In some embodiments, network 204 may facilitate communication between computing device 202, wearable 150, secured device 216, local gesture recognition device 218, and/or local wearer identification device 220. In at least one embodiment, network 204 may also at least partially facilitate communication between computing device 202 and external support system 224 via external connection 226 through barrier 228.

In at least one example, computing device 202 may be a computing device programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to provide contextual gesture-based control of connected devices.

Many other devices or subsystems may be connected to example system 100 in FIG. 1 and/or example system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Example systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example method 300 for contextual gesture-based control of connected devices. The steps shown in FIG. 3 may be performed by any suitable computer-executable code and/or computing system, including example system 100 in FIG. 1, example system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may receive, from a wearable, data representative of a gesture executed by a wearer of the wearable. For example, receiving module 104 may, as part of computing device 202 in FIG. 2, cause computing device 202 to receive, from wearable 150, gesture input data 206 representative of a gesture executed by wearer 208.

Receiving module 104 may receive gesture input data 206 from wearable 150 in a variety of contexts. For example, as shown in FIG. 2, wearable 150 may be connected to network 204. Hence, wearable 150 may transmit gesture input data 206 to receiving module 104 via network 204.

In some examples, a “gesture” may include any physical movement or pose made by a wearer of a wearable device. In some examples, a gesture may include one or more movements of a user's hand or other body part including, without limitation, movements like swiping a hand in a certain direction, making a specific hand shape, and so forth. In some examples, wearable 150 may be configured to record movement information as gesture input data (e.g., gesture input data 206) and transmit the gesture input data to receiving module 104.

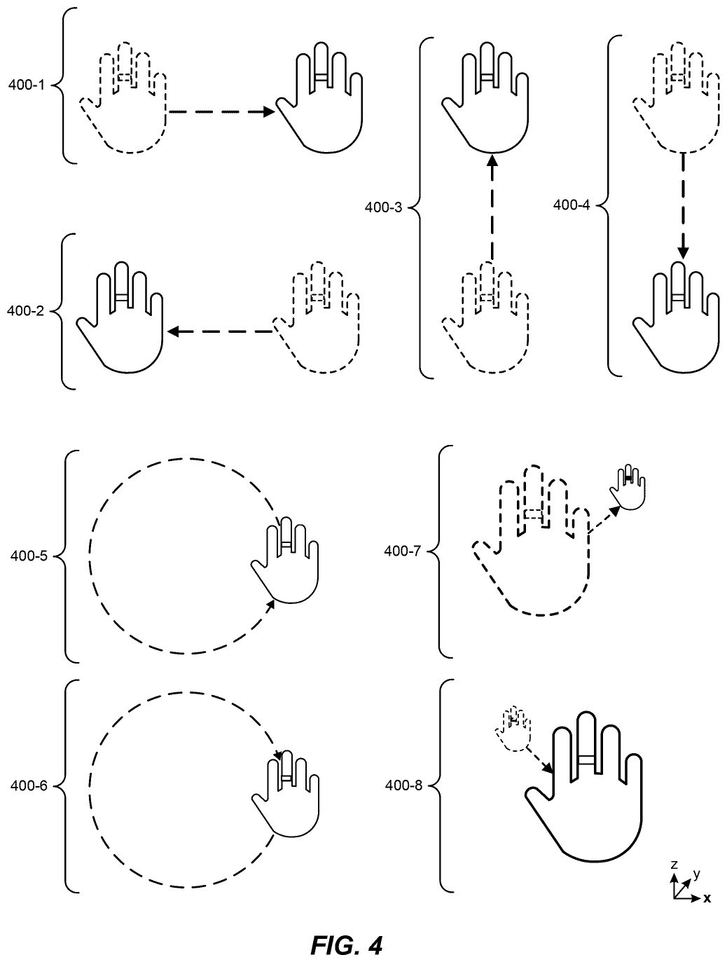

FIG. 4 illustrates example gestures 400 (e.g., example gesture 400-1 through example gesture 400-8). In each of these various example gestures, a wearer of a wearable device executes a gesture starting at a position indicated by a hand in dashed lines and passing the wearer's had along a path indicated by a dashed line and concluding at a position indicated by a hand in solid lines. The inclusion of example gestures 400 herein is not intended to limit the scope of this disclosure, as example gestures 400 are not an exhaustive list of all gestures that may be executed by wearer 208, recorded by wearable 150, and/or included as part of gesture input data 206. Indeed, gesture input data 206, recognized gesture 210, and/or external data 230 may include or represent any suitable wearer motion that may be captured by one or more sensors included in wearable 150.

In some examples, as a gesture may include any physical movement or pose made by a wearer of a wearable device, gesture input data (e.g., gesture input data 206) may include any data representative of any physical movement including, without limitation, direction, speed, strength, fluidity, timing, or sequence of movements recorded by a wearable (e.g., wearable 150). Moreover, in some examples, gesture input data 206 may additionally or alternatively include any data gathered by one or more sensors included in wearable 150.

Returning to FIG. 3, at step 320, one or more of the systems described herein may recognize, based on the data representative of the gesture, the gesture executed by the wearer. For example, recognizing module 106 may, as part of computing device 202 in FIG. 2, cause computing device 202 to recognize, based on gesture input data 206, the gesture executed by wearer 208.

Recognizing module 106 may recognize the gesture executed by wearer 208 in a variety of contexts. In some examples, recognizing module 106 may be configured to recognize the gesture locally. For example, local gesture recognition device 218 may be configured to recognize a gesture based on gesture input data 206. In some examples, local gesture recognition device 218 may include a device, component, or module that is part of network 204 and is designed to interpret and recognize human gestures from gesture input data 206 provided by wearable 150. Local gesture recognition device 218 may include and/or execute any suitable algorithms and processing capabilities to analyze gesture input data 206 and distinguish specific gesture patterns. The recognition process may include various steps such as preprocessing, feature extraction, and classification or matching.

Local gesture recognition device 218 may be “local” in that it may operate within a confined network environment (e.g., network 204) as opposed to relying on external networks or cloud-based services. This local operation can provide benefits in terms of reduced latency (e.g., due to elimination of network transmission times), increased privacy and security (i.e., as data doesn't have to leave the local network), and continued functionality even if external network connections are down.

In additional or alternative examples, recognizing module 106 may determine that the gesture exceeds a predetermined degree of gesture complexity. For example, gesture input data 206 may indicate that the gesture includes more than a single action or movement. Additionally or alternatively, gesture input data 206 may indicate that recognition of the gesture may require a high degree of precision. Additionally or alternatively, gesture input data 206 may indicate that the gesture includes a sequence of actions or motions rather than a single action or motion. Hence, in some examples, recognizing module 106 may determine, based on gesture input data 206, that the gesture exceeds a predetermined degree of complexity, and may transmit, via an external connection like external connection 226, gesture input data 206 to an external support system such as external support system 224.

External support system 224 may be configured to recognize, from gesture input data 206, more complex or complicated gestures using increased computing resources, specialized gesture recognition models (e.g., machine learning models), and so forth. External support system 224 may be referred to as “external” in that it may be physically or logically distinct and/or isolated from network 204. This distinction and/or isolation may be indicated in FIG. 2 by barrier 228.

Recognizing module 106 may further receive from external support system 224, via external connection 226, data representative of a recognized gesture, indicated in FIG. 2 by external data 230. Hence, in some examples, recognizing module 106 may further recognize the gesture executed by wearer 208 (e.g., recognized gesture 210) based on external data 230 received from external support system 224.

Communication between computing device 202 and external support system 224 may be executed over the internet or another network connection. In some examples, external support system 224 may reside in a cloud-based environment, a remote server, or a different part of an overarching network system.

Importantly, transmission of gesture input data 206 to external support system 224 may include encrypting gesture input data 206 within network 204 prior to transmission. Likewise, external data 230 may be encrypted by external support system 224 prior to transmission to computing device 202 and may be decrypted within network 204. This highlights the importance of privacy and security considerations when dealing with potentially sensitive user data in this context and is expressed within FIG. 2 by barrier 228.

Returning to FIG. 3, at step 330, one or more of the systems described herein may identify, based on the data representative of the gesture, the wearer via a machine learning model trained to identify biomechanical characteristics of wearers based on gesture data. For example, identifying module 108 may, as part of computing device 202 in FIG. 2, cause computing device 202 to identify, based on gesture input data 206, wearer 208 via machine learning model 148.

In some examples, biomechanical characteristics of wearers may refer to unique physical and mechanical traits related to the way individuals move or perform physical tasks, as captured by a wearable device (e.g., wearable 150). Biomechanical characteristics of wearers may include specific features or attributes that can be identified and differentiated through analysis of motion data, as included in gesture input data 206 from the wearable device. Biomechanical characteristics may include, without limitation, gait patterns, posture and/or movement, gesture dynamics (e.g., a unique way an individual performs a gesture, such speed, strength, fluidity, and sequence of the gesture), muscle activation patterns, and so forth. These characteristics can be recorded and interpreted through the sensors in a wearable device and can be used to train a machine learning model to recognize and distinguish individual wearers based on these unique biomechanical patterns.

In some examples, machine learning model 148 may be pre-trained using a corpus of generic biomechanical characteristics gathered from a variety of users and/or wearers of wearable devices. In additional or alternative examples, machine learning model 148 may be customized, personalized, and/or specifically trained using gesture data gathered from a specific wearer (e.g., wearer 208). Hence, in some examples, one or more of modules 102 (e.g., identifying module 108, executing module 110, etc.) may gather data representative of biomechanical characteristics of wearer 208 (e.g., biomechanical characteristics data 232) and may train machine learning model 148 to identify wearer 208 based on the data representative of biomechanical characteristics of the wearer.

Identifying module 108 may identify wearer 208 in a variety of contexts. For example, identification data 146 may include a pre-recorded biometric profile of wearer 208. Identifying module 108 may identify wearer 208 by inputting gesture input data 206 into machine learning model 148 and determining whether an output value from machine learning model 148 is within a pre-determined identification threshold of the pre-recorded biometric profile of wearer 208.

Moreover, in some examples, identifying module 108 may further authenticate an identity of wearer 208. In some examples, the output value from machine learning model 148 being within the pre-determined identification threshold of the pre-recorded biometric profile of wearer 208 may be sufficient to authenticate the identity of wearer 208. Additionally or alternatively, identifying module 108 may authenticate the identity of wearer 208 via one or more suitable additional identification factors associated with and/or provided by wearer 208, such as a username, a password, a voice print, a biometric identifier, an RFID, an NFC token, and so forth.

As noted above, machine learning model 148 may include any suitable type of machine learning model, and hence identifying module 108 may employ various methods and/or algorithms to use machine learning model 148 in identifying wearer 208. For example, in at least one embodiment, machine learning model 148 may include an autoencoder. An autoencoder is a type of ANN that may be used for unsupervised learning of efficient coding of complex information, and may often be employed to learn representations of data in a compressed form. In the context of user identification via biomechanical characteristics, an autoencoder can be trained to encode specific biomechanical patterns of users into a compact representation. When biomechanical data from an activity, such as gesturing, is input into the trained autoencoder, the autoencoder may compress this data into a lower-dimensional encoding. By comparing this encoding to previously established encodings for known wearers, embodiments of one or more of the systems described herein (e.g., identifying module 108) may identify a wearer based on the similarity of biomechanical patterns. This approach may leverage the unique biomechanical signatures of individuals to provide a novel method of user identification.

Hence, in some examples, one or more of modules 102 (e.g., identifying module 108, executing module 110, etc.) may train an autoencoder included as part of machine learning model 148 to identify the wearer based on the data representative of biomechanical characteristics of the wearer by using the autoencoder to generate, based on the data representative of biomechanical characteristics of the wearer, a wearer encoding corresponding to the wearer. Identifying module 108 may then identify the wearer via machine learning model 148 by generating, from gesture input data 206 via the autoencoder, a test encoding, and by determining that a difference between the test encoding and the wearer encoding is below a predetermined threshold.

As an additional example, in at least one embodiment, machine learning model 148 may include and/or implement a dynamic time warping (DTW) algorithm. A DTW algorithm may measure a similarity between two temporal sequences, which may vary in speed. It may be particularly effective for sequences that are out-of-sync or misaligned in time. In the context of user identification via biomechanical characteristics, a DTW algorithm can be trained to align and compare specific biomechanical patterns of users. When biomechanical data from an activity, such as gesturing, is input into the trained DTW model, the algorithm aligns this data with reference sequences. By comparing this aligned sequence to previously established sequences for known wearers, embodiments of one or more of the systems described herein (e.g., identifying module 108) may identify a wearer based on the similarity of biomechanical patterns. This approach may leverage the unique biomechanical signatures of individuals to provide a novel method of user identification.

Hence, in some examples, one or more of modules 102 (e.g., identifying module 108, executing module 110, etc.) may utilize a DTW algorithm included as part of machine learning model 148 to identify a wearer (e.g., wearer 208) based on the data representative of biomechanical characteristics of the wearer. Identifying module 108 may then identify the wearer via machine learning model 148 by comparing the gesture input data 206 with reference sequences using the DTW algorithm. The identification can be determined based on the similarity or distance measure produced by the DTW algorithm and, if this measure is below a predetermined threshold, it may indicate a match with a known wearer (e.g., wearer 208).

Like recognizing module 106, in some examples, identifying module 108 may be configured to recognize wearer 208 locally. For example, local wearer identification device 220 may be configured to identify a wearer (e.g., wearer 208) based on received gesture input (e.g., gesture input data 206) via a machine learning model (e.g., machine learning model 148). In some examples, local wearer identification device 220 may include a device, component, or module that is part of network 204 and is designed to identify wearers of wearables from gesture input data 206 provided by wearable 150 via machine learning model 148. Local wearer identification device 220 may include and/or execute any suitable algorithms and processing capabilities to analyze gesture input data 206 and distinguish users through specific biometric patterns. The identification process may include various steps such as preprocessing, feature extraction, and classification or matching.

As with local gesture recognition device 218 described above, local wearer identification device 220 may be “local” in that it may operate within a confined network environment (e.g., network 204) as opposed to relying on external networks or cloud-based services. This local operation can provide benefits in terms of reduced latency (e.g., due to elimination of network transmission times), increased privacy and security (i.e., as data doesn't have to leave the local network), and continued functionality even if external network connections are down.

As mentioned above, in some examples, one or more of modules 102 (e.g., recognizing module 106, identifying module 108, etc.) may determine that data included within gesture input data 206 may exceed a predetermined degree of gesture complexity. For example, gesture input data 206 may indicate that identification of wearer 208 from gesture input data 206 may require a high degree of precision and/or computing resources unavailable within network 204. Hence, in some examples, one or more of modules 102 (e.g., recognizing module 106, identifying module 108, etc.) may determine that gesture input data 206 exceeds a predetermined degree of complexity, and may transmit, via an external connection like external connection 226, gesture input data 206 to an external support system such as external support system 224.

External support system 224 may be configured to identify, from gesture input data 206, wearers using increased computing resources, specialized identification models (e.g., machine learning models), and so forth. These resources may not be available within network 204. External support system 224 may be referred to as “external” in that it may be physically or logically distinct and/or isolated from network 204. This may be indicated in FIG. 2 by barrier 228.

Identifying module 108 may further receive from external support system 224, via external connection 226, data representative of an identified wearer, indicated in FIG. 2 by external data 230. Hence, in some examples, identifying module 108 may identify wearer 208 based on data representative of an identified wearer included in external data 230 and received from external support system 224.

Returning to FIG. 3, at step 340, one or more of the systems described herein may execute, based on the gesture executed by the wearer and identifying the wearer, a security action directed to a secured device. For example, executing module 110 may, as part of computing device 202 in FIG. 2, cause computing device 202 to execute, based on the gesture executed by the wearer and identifying the wearer, security action 214 directed to secured device 216. In some examples, the secured device may be included in a network local to wearable 150 (e.g., network 204). In additional or alternative examples, the secured device may be included in a network that is separate from (e.g., logically and/or physically) network 204.

In some examples, a “security action” may include a procedural or operational action performed by a computer system or software in response to a recognized gesture and identification of the wearer, with a purpose of ensuring safety, protection, or controlled access of a secured device.

In some examples, a “secured device” may include a piece of electronic equipment that has protective measures in place to prevent unauthorized access or operation. These measures could include password protection, biometric scanning, encryption, or other security protocols. Secured devices may often be part of a network (e.g., network 204) and may communicate with other devices and systems within the network. Security may be a key feature of these devices, as they may contain, control, or process sensitive or personal data, or control critical operations. Examples of secured devices may include, without limitation, smart home devices (e.g., thermostats, door locks, security cameras, etc.), smart speaker devices, smart lighting devices, smart switches, security systems, home appliances, networking devices, landscaping devices, home automation devices, entertainment devices, electronic payment devices (e.g., near-field communication (NFC) payment terminals), and so forth. The secured nature of these devices means that they should only respond to approved commands from recognized sources or users, thus maintaining the security of the system they are part of. Hence, some embodiments of the systems and methods described herein may identify and authorize a wearer of a wearable (e.g., wearer 208 of wearable 150) to interact with secured devices (e.g., secured device 216) based on the recognition of the wearer's unique biomechanical characteristics and gestures.

Executing module 110 may execute a security action in a variety of ways depending on the context and the specific security protocols in place. Some examples of security actions may include verifying an identity of a wearer, authorizing the wearer to access a secured device based on the recognized gesture and the identification of the wearer, and so forth. Additional examples of security actions may include granting or denying access to a secured device, granting or denying access to specific or limited functionalities of a secured device, generating an alert or notification for a system administrator or rightful owner of a secured device in case of an unidentified or unauthorized user, locking down a secured device in case of an unidentified or unauthorized user (e.g., to prevent a security breach), and so forth.

Hence in at least one example, executing module 110 may execute a security action (e.g., security action 214) by determining whether wearer 208 has permission to interact with secured device 216. Upon determining that wearer 208 has permission to interact with secured device 216, executing module 110 may enable wearer 208 to interact with secured device 216 in any of the ways described herein (e.g., allowing wearer 208 to interact with secured device 216, activating or deactivating secured device 216, etc.). Conversely, upon determining that wearer 208 does not have permission to interact with secured device 216, preventing the wearer from interacting with the secured device in any of the ways described herein (e.g., denying access to secured device 216, notifying an administrator of the failed authentication, etc.).

As may be clear from the foregoing description, the systems and methods disclosed herein have many benefits over conventional options for user identification and/or user authentication. Employing gesture-based techniques as described herein may enhance a probability of capturing unique personal characteristics that can effectively identify a user. For authentication, this not only necessitates the physical presence of the person for authentication but also requires knowledge of a unique gesture. Further, it takes advantage of distinctive, subconscious locomotive traits that can be detected indirectly via sensors, thereby creating a robust foundation for enhanced security authentication methods.

This approach ensures that even if the gesture and the wearable device are compromised (for instance, if someone learns the gesture and then steals the wearable), it would still be highly challenging, if not impossible, for them to authenticate as the legitimate user.

By leveraging wearable devices to provide secure authentication methods, many everyday inconveniences can be significantly reduced. When combined with technologies like RFID or NFC, a compact wearable device, such as a ring or a watch, can authenticate the user for certain actions that would otherwise require other devices, for instance, facilitating contactless payments or unlocking doors/cars.

The systems and methods described herein could be further enhanced by integrating with other authentication mechanisms specific to wearable devices like biometric features, heart rate variability (HRV), gait monitoring, etc. This would lead to a more organic multi-factor authentication method that streamlines user interaction and reduces the effort required compared to traditional authentication methods, while maintaining a comparable or even superior level of security.

The present disclosure is also generally directed to systems and methods for authenticating wearers of wearables via biomechanical gestures. With the proliferation of wearable devices such as smart rings and smartwatches, there has been a growing interest in utilizing these devices for a variety of secure transactions and interactions. These may include payment processing, access control, and personalized user experiences. Traditional authentication methods, like passwords and personal identification numbers (PINs), can be vulnerable to security breaches and often add friction to the user experience.

The use of biometric data for authentication purposes has been explored as a potential solution to these challenges. By relying on unique physiological or behavioral characteristics of a user, biometric methods can offer a more secure and personalized means of authentication. However, existing systems often rely on specialized hardware, such as fingerprint or facial recognition scanners, which can be costly and inconvenient. Furthermore, traditional biometric methods may lack the versatility to adapt to various types of secure interactions and may not always provide real-time feedback or adaptability to the wearer's behavior.

Hence, some embodiments of the present disclosure may receive a request to execute a secured action with respect to a secured device. For example, a wearer of a wearable may interact with (e.g., tap) the wearable on a tap-to-pay sensor included in a near-field communication (NFC) payment terminal, which may cause an embodiment to receive data representative of the interaction as a request to execute a payment via the NFC payment terminal.

An embodiment of the systems and methods disclosed herein may then authenticate, by recognizing a structured continuous gesture executed by the wearer of the wearable via at least one sensor included in the wearable, the wearer of the wearable. As will be described in greater detail below, a structured continuous gesture may include a predefined, sequential movement pattern that a user must perform in a specific manner. As an example, the wearer may execute a predefined structured continuous gesture. A sensor included in the wearable may record data representative of the structured continuous gesture, and the embodiment may authenticate the wearer based on the data representative of the structured continuous gesture. Additionally or alternatively, an embodiment may present an authentication interface via a suitable computing device, and may receive authentication information (e.g., a username, a password, a multi-factor authentication token, etc.) via the authentication interface. Thus, an embodiment may authenticate the wearer using both a gesture and additional authentication information.

Additionally, an embodiment may also determine whether the wearer is authorized to provide the request to execute the secured action. In the foregoing example, the embodiment may determine whether the wearer has access to and/or has linked a payment method to the wearable that has sufficient funds to cover the cost of the requested transaction. Furthermore, an embodiment may, upon authenticating the wearer and determining that the wearer is authorized to provide the request to execute the secured action, execute the secured action (e.g., execute the requested NFC payment transaction).

By authenticating the wearer via one or more sensors included in a wearable, and by determining whether the wearer is authorized to request the secured action, embodiments of the systems and methods disclosed herein may provide a robust and personalized authentication process. This approach may leverage biomechanical characteristics and gestures, unique to individual wearers, to ensure secure and efficient transactions. The utilization of wearables, such as smart rings or smartwatches, may enable a seamless user experience without the need for additional specialized hardware. Additionally, some approaches to gesture-based authentication disclosed herein may be more privacy-preserving in comparison to other conventional user authentication approaches (e.g., username/password authentication, voice-based authentication, face recognition-based authentication, etc.). Moreover, by incorporating multi-step authentication processes, some embodiments of the systems and methods disclosed herein may offer a flexible solution adaptable to various secure actions, such as payments or access controls. Furthermore, the integration of tactile feedback and real-time gesture tracking in some embodiments described herein may enhance user engagement and may provide intuitive guidance during the authentication process, facilitating a user-friendly interface that combines convenience with state-of-the-art security.

FIG. 5 is a block diagram of an example system 500 for authenticating wearers of wearables via biomechanical gestures. As illustrated in this figure, example system 500 may include one or more modules 502 for performing one or more tasks. As will be explained in greater detail below, modules 502 may include a receiving module 504 that may receive a request to execute a secured action with respect to a secured device. Additionally, modules 502 may also include an authenticating module 506 that may authenticate, by recognizing a structured continuous gesture executed by a wearer of the wearable via at least one sensor included in the wearable, the wearer of the wearable.

Furthermore, modules 502 may also include a determining module 508 that may determine whether the wearer is authorized to provide the request to execute the secured action, and an executing module 510 that may, upon authenticating the wearer and determining that the wearer is authorized to provide the request to execute the secured action, execute the secured action.

As further illustrated in FIG. 5, example system 500 may also include one or more memory devices, such as memory 520. Memory 520 generally represents any type or form of volatile or non-volatile storage device or medium capable of storing data and/or computer-readable instructions. In one example, memory 520 may store, load, and/or maintain one or more of modules 502. Examples of memory 520 include, without limitation, RAM, ROM, flash memory, HDDs, SSDs, optical disk drives, caches, variations or combinations of one or more of the same, or any other suitable storage memory.

As further illustrated in FIG. 5, example system 500 may also include one or more physical processors, such as physical processor 530. As with physical processor 130, hysical processor 530 generally represents any type or form of hardware-implemented processing unit capable of interpreting and/or executing computer-readable instructions. In one example, physical processor 530 may access and/or modify one or more of modules 502 stored in memory 520. Additionally or alternatively, physical processor 530 may execute one or more of modules 502 to facilitate contextual gesture-based control of connected devices. Examples of physical processor 530 include, without limitation, microprocessors, microcontrollers, CPUs, FPGAs that implement softcore processors, ASICs, portions of one or more of the same, variations or combinations of one or more of the same, or any other suitable physical processor.

As also illustrated in FIG. 5, example system 500 may also include one or more stores of data, such as data store 540. Data store 540 may represent portions of a single data store or computing device or a plurality of data stores or computing devices. In some embodiments, data store 540 may be a logical container for data and may be implemented in various forms (e.g., a database, a file, file system, a data structure, etc.). Examples of data store 540 may include, without limitation, one or more files, file systems, data stores, databases, and/or database management systems such as an operational data store (ODS), a relational database, a NoSQL database, a NewSQL database, and/or any other suitable organized collection of data.

In some examples, data store 540 may include authentication data 542 that may include data related to and/or associated with authenticating a wearer of a wearable (e.g., wearable 550) and that may be accessed and/or analyzed by one or more of modules 502 (e.g., identifying module 508) to authenticate a wearer (e.g., at a time of execution of the structured continuous gesture). As will be described in greater detail below, this authentication data may include any suitable present and/or historic data associated with the wearer including, without limitation, a pre-recorded biometric profile of the wearer, structured continuous gesture data, unique gesture data, location tracking data associated with the wearer, habit data associated with the wearer, time data, temperature data, media data, media consumption data, smart home device data, and so forth.

In some examples, authentication data 542 may include a machine learning model 544. Machine learning model 544 may include a machine learning model trained to identify biomechanical characteristics of wearers based on input data (e.g., gesture data). In some examples, a machine learning model may include any a computational model that has been trained on data to recognize and distinguish unique attributes of individual users.

Machine learning models may leverage machine learning algorithms to learn from gesture data, which could include motion sensor data, accelerometer data, gyroscope data, magnetometer data, or other types of sensor data gathered by a wearable device as the wearer executes various movements or gestures. The characteristics identified could include, but are not limited to, specific patterns of movement, pace, strength, flexibility, or idiosyncrasies in how certain gestures are performed.

The model, through a process of training and validation with large volumes of gesture data, may learn to create a mapping between input gesture data and specific wearer characteristics. This may enable the model to take in new, unseen gesture data and predict or identify specific wearer characteristics based on its training. The identification of wearer's characteristics could be used for various applications, such as user authentication, personalized user experience, health monitoring, and more.

As also shown in FIG. 5, data store 540 may also include authorization data 546. Authorization data 546 may include any set of information that may be used to determine whether a wearer of a wearable is permitted to execute a secured action. In some examples, authorization data 546 may include, but is not limited to, user credentials, payment method details, access permissions, security tokens, or other related information that verifies the wearer's entitlement or capacity to perform the requested transaction or interaction. By way of illustration, in the context of an NFC payment terminal, authorization data 546 may be linked to a specific financial account, and may be used to confirm that the wearer has sufficient funds or credit to complete a payment.

Additionally, as shown in FIG. 5, data store 540 may also include secured action data 548 that may include data for executing secured actions related to secured devices, such as one or more application programming interfaces (APIs) for providing commands to and/or receiving data from one or more connected devices, one or more configurations of a set of secured devices, one or more programs for executing one or more secured actions, and so forth. By way of illustration, in some examples, secured action data 548 may include data representative of a configuration of, and/or one or more methods of interacting electronically and/or programmatically with, one or more secured devices.

As is further shown in FIG. 5, example system 500 may also include a wearable 550. As mentioned above, in some examples, a “wearable” or “wearable device” generally includes devices designed and/or intended to be worn by a wearer and/or integrated into clothing. These devices may have the ability to connect to the internet, sync with other devices (e.g., mobile phones, personal computers, tablet computers, etc.) and provide a variety of features including but not limited to tracking physical activity (e.g., steps, heart rate, calories burned, etc.), monitoring biometric information (e.g., blood pressure, blood glucose levels, sleep quality, etc.), providing notifications (e.g., voice calls, emails, text messages, reminders, etc.), supporting navigation (e.g., via positioning systems, Wi-Fi, triangulation, etc.), making contactless payments, voice control, and/or gesture recognition.

In some examples, a wearable (e.g., wearable 550) may include a smart ring. Smart rings are a specific type of wearable technology that may be worn on a wearer's finger, similar to a traditional ring. They can be designed to provide various functionalities like those mentioned above and are often focused on discrete or minimalist design to maintain the outward style aspect of a ring while adding smart capabilities. Some may even include bio-sensing features such as measuring stress, body temperature, or providing an electrocardiogram (ECG). These features can vary greatly depending on the particular make and model of the smart ring, and hence this disclosure is not limited to any particular wearable device.

As further shown in FIG. 5, wearable 550 may include at least one sensor 552. Wearable devices may include a variety of sensors depending on their specific design and function. These sensors may include an accelerometer, a gyroscope, a magnetometer, a heart rate sensor, a photoplethysmography sensor, a GPS sensor, a barometer, an ambient light sensor, a skin temperature sensor, a bioimpedance sensor, a galvanic skin response sensor, one or more capacitive sensors, and so forth. This list is illustrative and non-exhaustive, as specific combinations and types of sensors can vary widely based on the particular application and design of the wearable device.

In additional or alternative examples, a wearable (e.g., wearable 550) may include any device capable of (1) gathering data representative of a gesture executed by a wearer of the wearable, and (2) transmitting that data to one or more of modules 502 (e.g., receiving module 504), such as a smart phone, an outside-in tracking system, an inside-out tracking system, a computer vision tracking system, and so forth.

In some examples, wearable 550 may include a tactile feedback function 554. As will be described in greater detail below, tactile feedback function 554 may provide real-time tactile feedback (e.g., to a wearer) during the authentication process. For example, when a wearer of a wearable device, such as a smart ring or smartwatch, performs a predefined gesture to execute a secured action like a payment via an NFC terminal, the tactile feedback function 554 may generate a distinct haptic response. This response could be, without limitation, a vibration or other tactile sensation that confirms the recognition of the gesture or provides guidance during the authentication process. Tactile feedback function 554 may coordinate with hardware included in wearable 550 (e.g., a vibration motor, a haptic engine, etc.) to generate appropriate physical sensations in response to certain triggers or conditions.

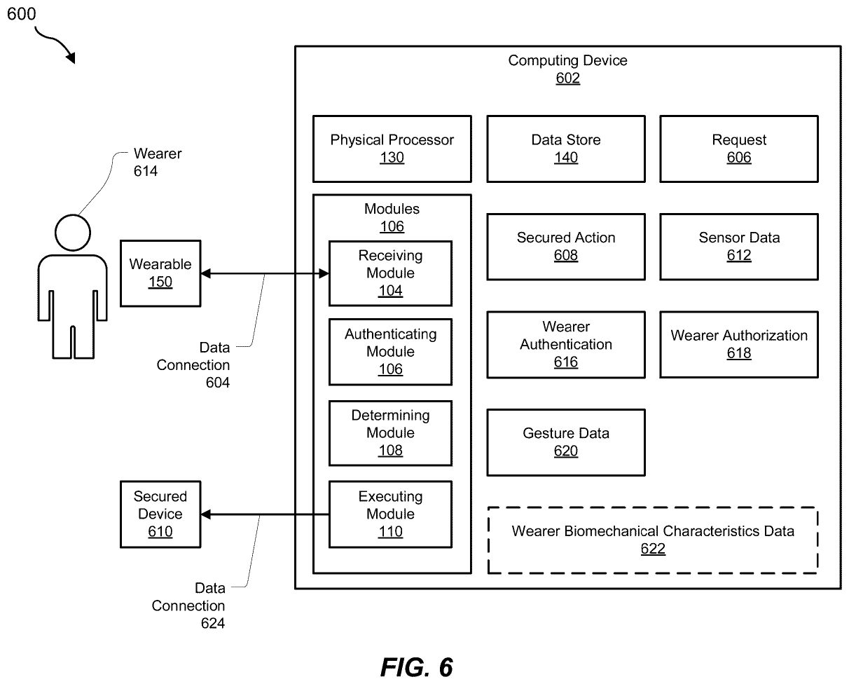

Example system 500 in FIG. 5 may be implemented in a variety of ways. For example, all or a portion of example system 500 may represent portions of an example system 600 (“system 600”) in FIG. 6. FIG. 6 is a block diagram of an example system 600 that implements a system for contextual gesture-based control of connected devices. As shown in FIG. 6, example system 600 may include a computing device 602 in communication with wearable 550 via data connection 604 and a secured device 610 via data connection 624. In at least one example, computing device 602 may be programmed with one or more of modules 502.

In at least one embodiment, one or more modules 502 from FIG. 5 may, when executed by computing device 602, cause computing device 602 to perform one or more operations to enable authentication of wearers of wearables via biomechanical gestures. For example, as will be described in greater detail below, receiving module 504 may cause computing device 602 to receive a request (e.g., request 606) to execute a secured action (e.g., secured action 608) with respect to a secured device (e.g., secured device 610).

Additionally, authenticating module 506 may cause computing device 602 to authenticate a wearer of the wearable (e.g., wearer 614), by recognizing via at least one sensor included in the wearable (e.g., sensor data 612 gathered via sensor 552), a structured continuous gesture executed by the wearer of a wearable. Furthermore, determining module 508 may cause computing device 602 to determine whether the wearer is authorized to provide the request to execute the secured action. Moreover, executing module 510 may cause computing device 602 to, upon authenticating the wearer (e.g., wearer authentication 616) and determining that the wearer is authorized to provide the request to execute the secured action (e.g., wearer authorization 618), execute the secured action (e.g., via data connection 624).

As will be described in greater detail below, in some examples, the at least one sensor included in the wearable (e.g., sensor 552) may include a movement tracking sensor, and authenticating module 506 may authenticate the wearer of the wearable (e.g., wearer 614 of wearable 550) by receiving, from the movement tracking sensor, data representative of a gesture executed by the wearer of the wearable (e.g., gesture data 620). Authenticating module 506 may further recognize, based on the data representative of the gesture, the gesture executed by the wearer, and may identify, based on the data representative of the gesture, the wearer via a machine learning model trained to identify biomechanical characteristics of wearers based on gesture data (e.g., machine learning model 544).

Additionally, as will be described in greater detail below, in some examples, one or more of modules 502 (e.g., receiving module 504, authenticating module 506, etc.) may also gather data representative of biomechanical characteristics of the wearer (e.g., wearer biomechanical characteristics data 622) and may train the machine learning model to identify the wearer based on the data representative of biomechanical characteristics of the wearer.

Computing device 602 generally represents any type or form of computing device capable of reading and/or executing computer-executable instructions. Examples of computing device 602 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

In at least one example, computing device 602 may be a computing device programmed with one or more of modules 502. All or a portion of the functionality of modules 502 may be performed by computing device 602 and/or any other suitable computing system. As will be described in greater detail below, one or more of modules 502 from FIG. 5 may, when executed by at least one processor of computing device 602, may enable computing device 602 to authenticate wearers of wearables via biomechanical gestures.

Data connection 604 generally represents any medium or architecture capable of facilitating communication and/or data transfer between computing device 602 and wearable 550. Likewise, data connection 624 generally represents any medium capable of facilitating communication and/or data transfer between computing device 602 and secured device 610. Examples of data connection 604 and/or data connection 624 include, without limitation, an intranet, a WAN, a LAN, a Personal Area Network (PAN), the Internet, Power Line Communications (PLC), a cellular network (e.g., a Global System for Mobile Communications (GSM) network, a code-division multiple access (CDMA) network, a Long-Term Evolution (LTE) network, etc.), universal serial bus (USB) connections, NFC data connections, and the like. Data connection 604 and/or data connection 624 may facilitate communication or data transfer using wireless or wired connections. In some embodiments, data connection 604 and/or data connection 624 may facilitate communication between computing device 602, wearable 550, and/or secured device 610.

Many other devices or subsystems may be connected to example system 500 in FIG. 5 and/or example system 600 in FIG. 6. Conversely, all of the components and devices illustrated in FIGS. 5 and 2 need not be present to practice the embodiments described and/or illustrated herein. The devices and subsystems referenced above may also be interconnected in different ways from those shown in FIG. 6. Example system 500 and example system 600 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 7 is a flow diagram of an example method 700 for authenticating wearers of wearables via biomechanical gestures. The steps shown in FIG. 7 may be performed by any suitable computer-executable code and/or computing system, including example system 500 in FIG. 5, example system 600 in FIG. 6, and/or variations or combinations of one or more of the same. In one example, each of the steps shown in FIG. 7 may represent an algorithm whose structure includes and/or is represented by multiple sub-steps, examples of which will be provided in greater detail below.

As illustrated in FIG. 7, at step 710, one or more of the systems described herein may receive a request to execute a secured action with respect to a secured device. For example, receiving module 504 may, as part of computing device 602 in FIG. 6, cause computing device 602 to receive request 606 to execute secured action 608 with respect to secured device 610.

Receiving module 504 may receive request 606 from wearable 550 in a variety of contexts. For example, as shown in FIG. 6, wearable 550 may be connected to computing device 602 via data connection 604. Hence, wearable 550 may transmit request 606 to receiving module 504 via data connection 604. Likewise, as will be described in greater detail below, in some examples, wearable 550 may transmit sensor data 612, and/or gesture data 620 to one or more of modules 502 (e.g., receiving module 504, authenticating module 506, etc.) via data connection 604.

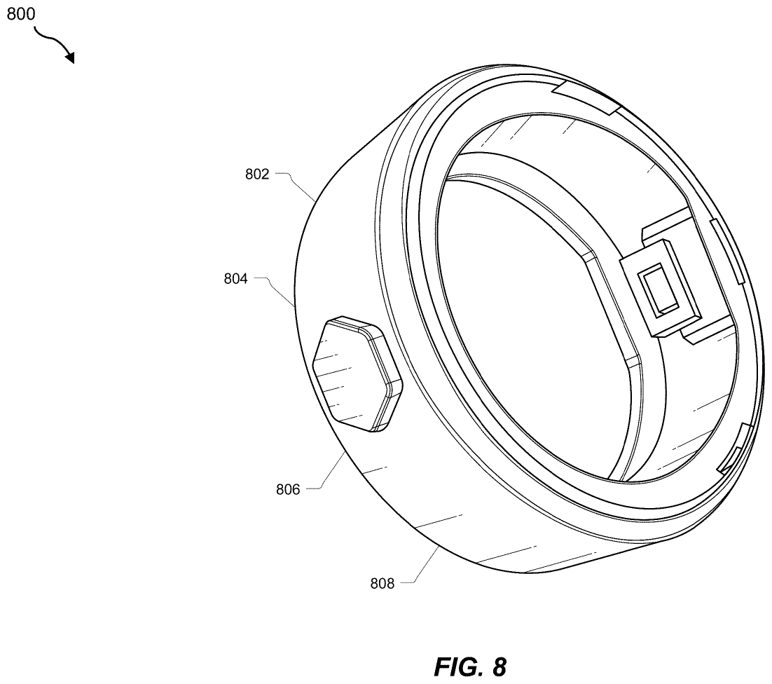

As described above in connection with FIG. 5, a wearable device such as wearable 550 may include a device designed and/or intended to be worn by a wearer and/or integrated into clothing, such as a smart ring, a smart band, a smart watch, a smartphone, and so forth. FIG. 8 shows a perspective view 800 of an example smart ring device 802 that may be used in connection with some embodiments of the systems and methods disclosed herein. Smart ring device 802 may include a sensor 804, an NFC antenna 806, and a tactile feedback function 808. In some examples, sensor 804 may implement a sensor such as sensor 552, NFC antenna 806 may implement at least part of a wireless connection such as data connection 604, and tactile feedback function 808 may implement a tactile feedback function like tactile feedback function 554.

Request 606 may include or represent any data that may indicate a request (e.g., by wearer 614) to execute a secured action. By way of illustration, in an example where secured device 610 includes an NFC payment terminal, receiving module 504 may receive request 606 by detecting a physical interaction between the wearable and the NFC payment terminal, such as a tap of wearable 550 against and/or in proximity to the NFC payment terminal. This detected physical interaction may indicate or manifest an intent by wearer 614 to engage in a secured action of executing an NFC payment process via wearable 550 and the NFC payment terminal. Hence, in this example, request 606 and/or sensor data 612 may include data related to execution of the NFC payment process via wearable 550 and the NFC payment terminal, such as account information, identifying information related to wearer 614, and so forth.

Returning to FIG. 7, at step 720, one or more of the systems described herein may authenticate, by recognizing a structured continuous gesture executed by a wearer of the wearable via at least one sensor included in the wearable, the wearer of the wearable. For example, authenticating module 506 may, as part of computing device 602 in FIG. 6, cause computing device 602 to authenticate wearer 614 by recognizing a structured continuous gesture executed by wearer 614 from data gathered by sensor 552.

In some examples, “authentication” may include any process of verifying any identity of a user, device, or other entity in a computer system (e.g., example system 500, example system 600, etc.). Authentication may generally involve validating personal credentials such as a username and password, a biometric scan, or a security token. Authentication may generally ensure that a user is genuine and can be trusted. Hence, authenticating module 506 may use data derived from sensor 552 included in wearable 550 to authenticate wearer 614 within example system 500, example system 600, and so forth.

Authenticating module 506 may authenticate wearer 614 via sensor 552 in a variety of contexts. For example, as described above, sensor 552 may include a movement tracking sensor. Authenticating module 506 may receive from sensor 552, data representative of a structured continuous gesture executed by the wearer of the wearable, such as gesture data 620. Authenticating module 506 may recognize, based on gesture data 620, the gesture executed by the wearer.

In some examples, as mentioned above, a “gesture” may include any physical movement or pose made by a wearer of a wearable device. In some examples, a gesture may include one or more movements of a user's hand or other body part including, without limitation, movements like swiping a hand in a certain direction, making a specific hand shape, and so forth. In some examples, wearable 550 and/or sensor 552 may be configured to record movement information as gesture input data (e.g., gesture data 620) and transmit the gesture input data to receiving module 504 and/or authenticating module 506. In some examples, a “structured continuous gesture” may include a predefined sequential movement pattern. In some examples, a wearer may perform the structured continuous gesture continuously, meaning generally in a fluid motion and/or without interruptions.

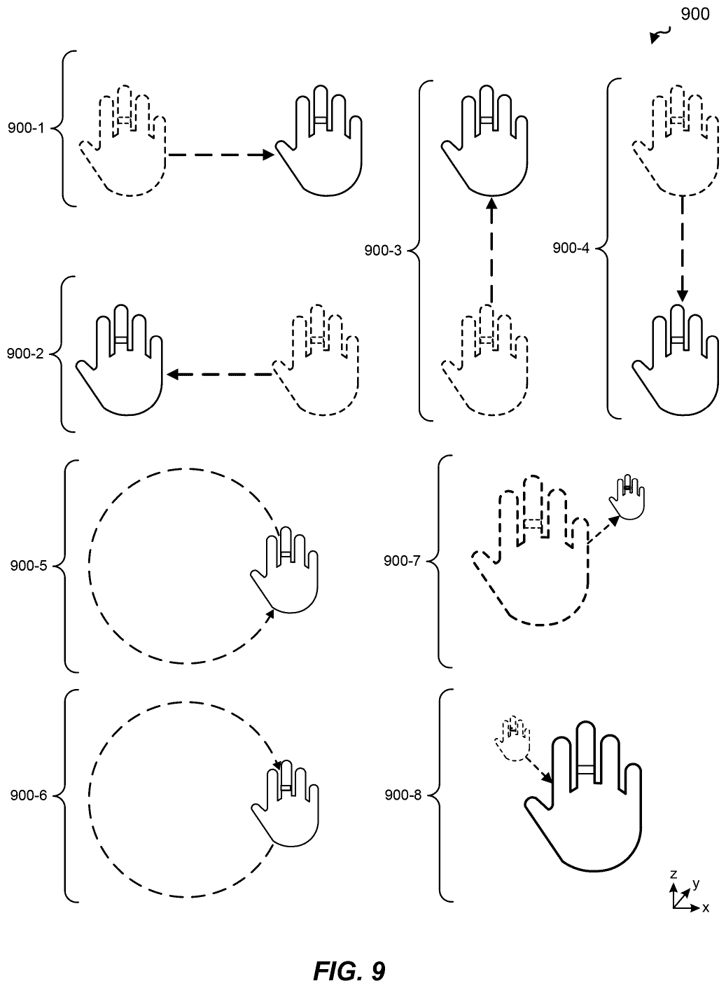

FIG. 9 illustrates example gestures 900 (e.g., example gesture 900-1, example gesture 900-2, example gesture 900-3, example gesture 900-4, example gesture 900-5, example gesture 900-6, example gesture 900-7, and example gesture 900-8). In each of these various example gestures, a wearer of a wearable device executes a gesture starting at a position indicated by a hand in dashed lines and passing the wearer's had along a path indicated by a dashed line and concluding at a position indicated by a hand in solid lines. The inclusion of example gestures 900 herein is not intended to limit the scope of this disclosure, as example gestures 900 are not an exhaustive list of all gestures that may be executed by wearer 614, recorded by wearable 550, and/or included as part of gesture data 620. Indeed, gesture data 620 may include or represent any suitable wearer motion that may be captured by one or more of sensors 552 included in wearable 550.

In some examples, as a gesture may include any physical movement or pose made by a wearer of a wearable device, gesture data (e.g., gesture data 620) may include any data representative of any physical movement including, without limitation, direction, speed, strength, fluidity, timing, or sequence of movements recorded by a wearable (e.g., wearable 550). Moreover, in some examples, gesture data 620 may additionally or alternatively include any data gathered by one or more sensors (e.g., sensor 552) included in wearable 550.

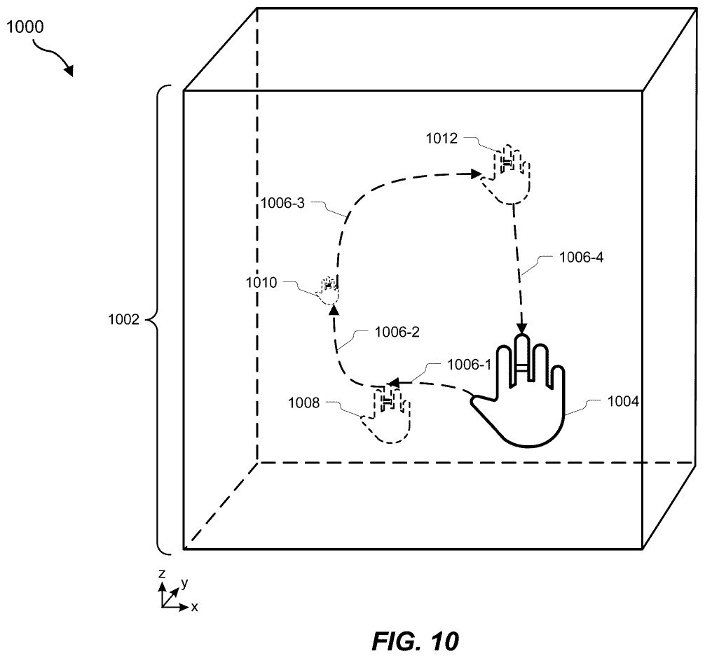

FIG. 10 includes a simplified perspective view 1000 of an execution of a structured continuous gesture. In this illustration, a three-dimensional space 1002 is shown, within which a wearer of a wearable may execute a structured continuous gesture. As shown, the wearer may begin the structured continuous gesture with a hand (wearing a wearable) at position 1004. The wearer may execute the structured continuous gesture by moving the hand along path 1006-1 to position 1008, along path 1006-2 to position 1010, along path 1006-3 to position 1012, and along path 1006-4 to return to position 1004. Note that the structured continuous gesture shown in FIG. 10 is provided by way of illustration only, as a structured continuous gesture may include any suitable open or closed curve having any suitable shape, size, and/or dimensionality.

A structured continuous gesture may be structured in a sense that the gesture it may be continuously defined over a predetermined space or framework, such as a three-dimensional lattice. Such a lattice may include a three-dimensional topological structure that includes a repeating arrangement of points or nodes. Hence, a structured continuous gesture may be described as an exact sequence of transitions between immediately neighboring points on a three-dimensional lattice. That is, a structured continuous gesture may include a continuous movement from a starting point to an ending point, where the movement may be described as “passing through” a sequence of points included in the three-dimensional lattice, such that each two consecutive points in the sequence are neighbors on the three-dimensional lattice. In some examples, each point may appear multiple times in the sequence. Various rules may be defined for valid transitions between points, but in general two points may be said to be neighbors if and only if, by initiating a unidirectional movement at one of the points and continuing to move in an unchanged direction, the other point will eventually be reached without passing through any other point in the lattice.

Using this concept of a structured continuous gesture, an authentication interface can thus be constructed where wearer movement data, as recorded by wearable 550, may be mapped to an abstract or virtual representation of a three-dimensional lattice. Hence, in some examples, one or more of modules 502 (e.g., authenticating module 506) may map movement data, received from wearable 550, onto an abstract or virtual representation of a three-dimensional lattice. A user (e.g., wearer 614) may be presented or pre-instructed with a set of valid movement directions that may mark or designate valid transitions between neighboring points on the three-dimensional lattice. When executing a structured continuous gesture, the user may be required to continue moving in an unchanging direction when moving between two points on the three-dimensional lattice. Upon arriving at a particular point on the lattice, the user may be provided with a distinct tactile feedback. The distinct tactile feedback may indicate to the user a position of the user on the abstract or virtual representation of the three-dimensional lattice, and may further indicate a time to begin moving in a new direction, toward another point on the abstract or virtual representation of the three-dimensional lattice.

A starting point on the abstract or virtual three-dimensional lattice may be arbitrary, determined by the user interface (e.g. with a distinct tactile feedback), and so forth. A user may successfully authenticate when the wearer performs the correct gesture at the correct time. That is, the wearer may successfully authenticate if the wearer performs a pre-determined gesture such that the relevant recorded movement data translates to a pre-stored and/or pre-determined sequence of point transitions on the lattice within a pre-determined threshold.

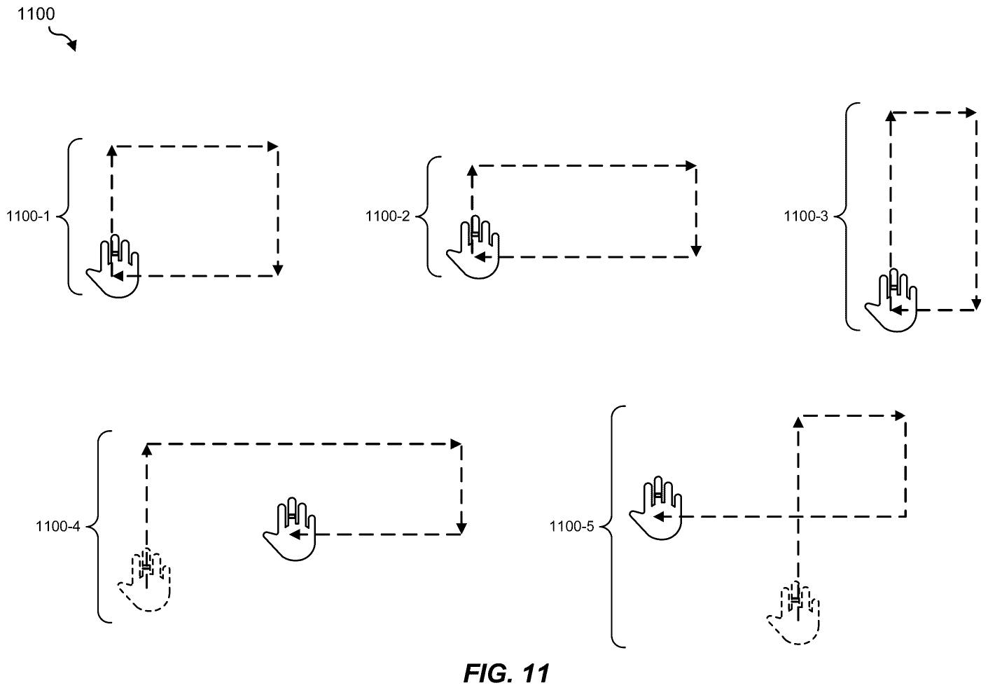

FIG. 11 illustrates example structured continuous gestures 1100. As mentioned above, a structured continuous gesture may include any suitable open or closed curve having any suitable shape, size, and/or dimensionality. Hence, structured continuous gesture 1100-1 has an approximately square shape, structured continuous gesture 1100-2 has a rectangular shape with a vertical dimension shorter than a horizontal dimension, and structured continuous gesture 1100-3 has a rectangular shape with a vertical dimension longer than a horizontal dimension. Structured continuous gesture 1100-4 includes an open curve, and structured continuous gesture 1100-5 includes a self-intersecting curve. Although structured continuous gestures 1100 are only shown in two dimensions, this is for convenience and by way of illustration only and not by way of limitation, as a structured continuous gesture may have or may take any two- or three-dimensional shape.

In some examples, to provide an increased level of security, a duration of time during which the user is required to maintain a unidirectional movement in order for a successful transition from one point to another may be varied (e.g., randomly) between gestures, authentication attempts, or even between point transitions included in a structured continuous gesture (i.e., within a single authentication attempt). Hence, a tactile feedback may be provided upon expiration of the duration of time. In effect, two recordings or subsets of a recording of movement data marking movement maintained for the same amount of time may map to a different number of point transitions, either between different sessions or even within the same session. In at least this way, transitions on the abstract or virtual lattice may not be viewed or inferred by a potentially malicious observer. Thus, a particular structured continuous gesture may remain private to the user even if all gesture-based authentication attempts are performed in public and/or fully in an observer's sight.

As an example, suppose the user is given options of six valid movements: “left”, “right”, “down”, “up”, “forward”, “backward” and the correct sequence of transitions is “forward”, “forward”, “right”, “right”, “backward”, “left”, each marking a single point transition in the described direction relative to a predetermined direction (e.g., a direction relative to a direction that the user is facing). Depending on the times between each tactile feedback received by the user, marking an end of a transition to a point, what the user's gesture would appear to trace out to an external observer, might be a rectangle, a square, a non-enclosed shape, semi-enclosed shape with one or more crossed lines, etc.

In some embodiments, a wearer may have previously defined a structured continuous gesture as a predefined control set of movement data. For example, the wearer may have defined a “gesture-based password” that includes a structured continuous gesture. Hence, in some examples, authenticating wearer 614 of wearable 550 may include receiving, from the movement tracking sensor, movement data associated with execution by the wearer of the structured continuous gesture, and recognizing, based on the movement data, the structured continuous gesture executed by the wearer. One or more of modules 502 (e.g., authenticating module 506 may therefore recognize the structured continuous gesture executed by the wearer by comparing the movement data to the predetermined control set of movement data.

As described above, in some examples, authenticating module 506 may provide prompts, such as tactile feedback (e.g., vibrations) to guide the wearer as the wearer executes a structured continuous gesture along a virtual lattice. The prompts may be provided via a tactile feedback function of wearable 550 so as to maintain security of the gesture. The position on the lattice may be known only to the wearer, making it difficult for a malicious observer to replicate the gesture. The security of this method can be further enhanced by introducing random variations in the time between vibrations, even when the user is moving in the same direction.

Hence, in some examples, authenticating module 506 may identify a wearer initiation of a first portion of a gesture, may track, via the wearable, an execution of the first portion of the gesture, may determine that the first portion of the gesture has been executed, and may prompt the wearer to execute a second portion of the gesture. Authenticating module 506 may prompt the wearer to execute the second portion of the gesture by initiating a tactile feedback function of the wearable in response to determining that the first portion of the gesture has been executed. In some examples, authenticating module 506 may track the execution of the gesture (e.g., the first portion of the gesture, the second portion of the gesture, etc.) by tracking, in three-dimensional space, a position of the wearable.

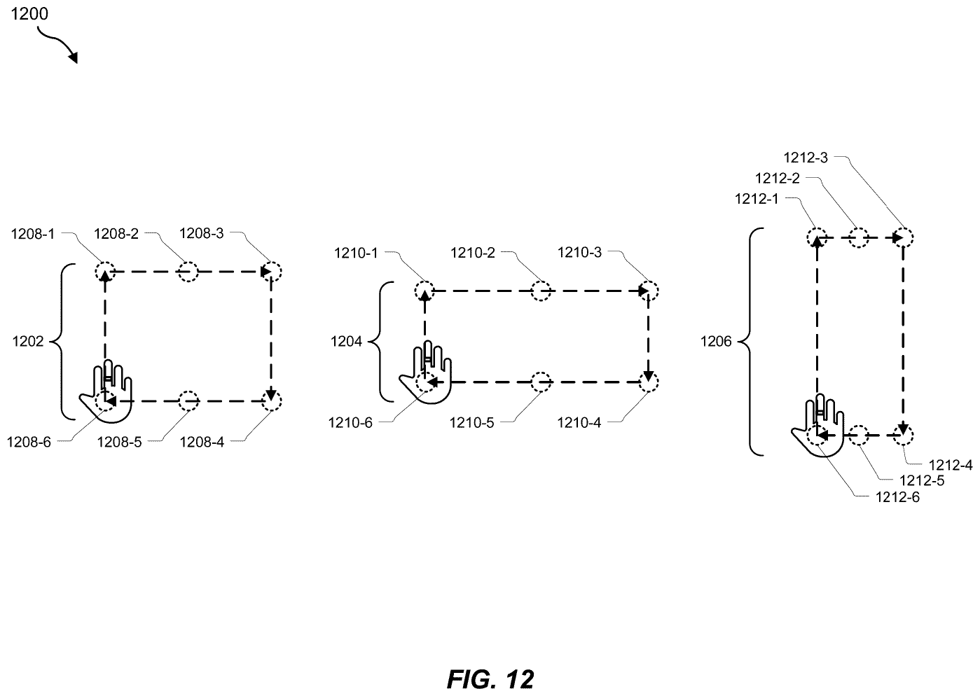

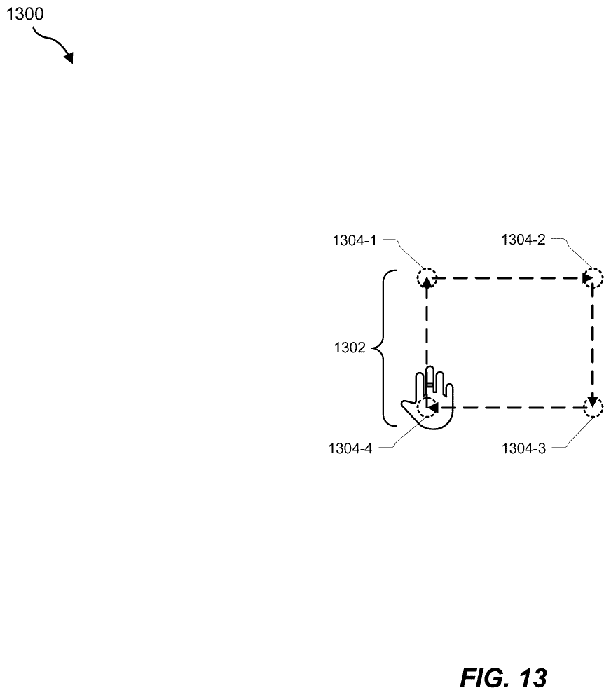

FIG. 12 and FIG. 13 provide illustrative examples of how a wearer of a wearable device may receive tactile feedback during the execution of a structured continuous gesture. FIG. 12 includes a view 1200 that includes visual representations of structured continuous gesture 1202, structured continuous gesture 1204, and structured continuous gesture 1206. As shown, each of the structured continuous gestures in FIG. 12 include a rectangular shape, with an upward vertical gesture followed by a rightward horizontal gesture, a downward vertical gesture, and a leftward horizontal gesture. In this example, a wearer may have pre-defined, for authentication purposes, an authentication gesture that includes (1) an upward vertical gesture with one tactile prompt, (2) a rightward horizontal gesture with two tactile prompts, (3) a downward vertical gesture with one tactile prompt, and (4) a leftward horizontal gesture with two tactile prompts. Each of structured continuous gesture 1202, structured continuous gesture 1204, and structured continuous gesture 1206 may represent a successful execution of this pre-defined authentication gesture. The example illustrated in FIG. 13, described in greater detail below, may represent an unsuccessful execution of this pre-defined authentication gesture.

In structured continuous gesture 1202, a wearer may begin executing the structured continuous gesture by moving their hand vertically. At a first time, following beginning of the upward vertical gesture, a first tactile feedback 1208-1 may be provided to the wearer, which may indicate to the wearer that they should begin executing the rightward horizontal gesture. At a second time, following the first tactile feedback 1208-1, a second tactile feedback 1208-2 may be provided as the wearer executes the rightward horizontal gesture, which may indicate to the wearer that they should continue with the rightward horizontal gesture. At a third time, following the second tactile feedback 1208-2, a third tactile feedback 1208-3 may be provided as the wearer continues with the rightward horizontal gesture, which may indicate to the wearer that they should begin executing the downward vertical gesture. At a fourth time, following the third tactile feedback, a fourth tactile feedback 1208-4 may be provided as the wearer continues with the downward vertical gesture, which may indicate to the wearer that they should begin executing the leftward horizontal gesture. At a fifth time, following the fourth tactile feedback 1208-4, a fifth tactile feedback 1208-5 may be provided which may indicate to the wearer that they should continue with the leftward horizontal gesture. Finally, at a sixth time, following the fifth tactile feedback 1208-5, a sixth tactile feedback 1208-6 may be provided during execution of the leftward horizontal gesture, which may indicate to the wearer that the execution of structured continuous gesture 1202 has concluded.

In structured continuous gesture 1204, a wearer may begin executing the structured continuous gesture by moving their hand vertically. At a first time, following beginning of the upward vertical gesture, a first tactile feedback 1210-1 may be provided to the wearer, which may indicate to the wearer that they should begin executing the rightward horizontal gesture. At a second time, following the first tactile feedback 1210-1, a second tactile feedback 1210-2 may be provided as the wearer executes the rightward horizontal gesture, which may indicate to the wearer that they should continue with the rightward horizontal gesture. At a third time, following the second tactile feedback 1210-2, a third tactile feedback 1210-3 may be provided as the wearer continues with the rightward horizontal gesture, which may indicate to the wearer that they should begin executing the downward vertical gesture. At a fourth time, following the third tactile feedback, a fourth tactile feedback 1210-4 may be provided as the wearer continues with the downward vertical gesture, which may indicate to the wearer that they should begin executing the leftward horizontal gesture. At a fifth time, following the fourth tactile feedback 1210-4, a fifth tactile feedback 1210-5 may be provided which may indicate to the wearer that they should continue with the leftward horizontal gesture. Finally, at a sixth time, following the fifth tactile feedback 1210-5, a sixth tactile feedback 1210-6 may be provided during execution of the leftward horizontal gesture, which may indicate to the wearer that the execution of structured continuous gesture 1204 has concluded.

In structured continuous gesture 1206, a wearer may begin executing the structured continuous gesture by moving their hand vertically. At a first time, following beginning of the upward vertical gesture, a first tactile feedback 1212-1 may be provided to the wearer, which may indicate to the wearer that they should begin executing the rightward horizontal gesture. At a second time, following the first tactile feedback 1212-1, a second tactile feedback 1212-2 may be provided as the wearer executes the rightward horizontal gesture, which may indicate to the wearer that they should continue with the rightward horizontal gesture. At a third time, following the second tactile feedback 1212-2, a third tactile feedback 1212-3 may be provided as the wearer continues with the rightward horizontal gesture, which may indicate to the wearer that they should begin executing the downward vertical gesture. At a fourth time, following the third tactile feedback, a fourth tactile feedback 1212-4 may be provided as the wearer continues with the downward vertical gesture, which may indicate to the wearer that they should begin executing the leftward horizontal gesture. At a fifth time, following the fourth tactile feedback 1212-4, a fifth tactile feedback 1212-5 may be provided which may indicate to the wearer that they should continue with the leftward horizontal gesture. Finally, at a sixth time, following the fifth tactile feedback 1212-5, a sixth tactile feedback 1212-6 may be provided during execution of the leftward horizontal gesture, which may indicate to the wearer that the execution of structured continuous gesture 1206 has concluded.

In the examples shown in FIG. 12, although a general shape of structured continuous gesture 1202, structured continuous gesture 1204, and structured continuous gesture 1206 may differ, they may each cause authenticating module 506 to successfully authenticate the wearer.

FIG. 13 provides an additional illustrative example of how a wearer of a wearable device may receive tactile feedback during the execution of a structured continuous gesture. In this example, as in the example illustrated in FIG. 12, a wearer may have pre-defined, for authentication purposes, an authentication gesture that includes (1) an upward vertical gesture with one tactile prompt, (2) a rightward horizontal gesture with two tactile prompts, (3) a downward vertical gesture with one tactile prompt, and (4) a leftward horizontal gesture with two tactile prompts. As noted above, this example may represent an unsuccessful execution of this pre-defined authentication gesture.

FIG. 13 includes a view 1300 that includes a structured continuous gesture 1302. In this example, a malicious wearer may have previously seen a wearer execute structured continuous gesture 1202, but may lack information regarding timing and/or sequencing of one or more of first tactile feedback 1208-1 through sixth tactile feedback 1208-6.

In this example, the malicious wearer may begin executing a structured continuous gesture by moving their hand vertically. At a first time, following beginning of the upward vertical gesture, a first tactile feedback 1304-1 may be provided to the malicious wearer. Upon receiving first tactile feedback 1304-1, the malicious wearer may begin executing the rightward horizontal gesture. At a second time, a second tactile feedback 1304-2 may be provided. However, because the wearer may lack knowledge of the authentication gesture, the wearer may misinterpret second tactile feedback 1304-2 as indicating that they should begin executing the downward vertical gesture. At a third time, a third tactile feedback 1304-3 may be provided. The malicious wearer may further misinterpret the third tactile feedback 1304-3 as indicating that the malicious wearer should begin executing the leftward horizontal gesture. Finally, a fourth tactile feedback 1304-4 may be provided, which the malicious wearer may misinterpret as indicating that the structured continuous gesture is complete. As the malicious wearer has failed to correctly execute the pre-defined authentication gesture, authenticating module 506 will not authenticate the malicious wearer.

In some examples, authenticating module 506 may further identify wearer 614 based on the recognized gesture and via a machine learning model trained to identify biomechanical characteristics of wearers based on gesture data such as machine learning model 544.

In some examples, biomechanical characteristics of wearers may refer to unique physical and mechanical traits related to the way individuals move or perform physical tasks, as captured by a wearable device (e.g., wearable 550). Biomechanical characteristics of wearers may include specific features or attributes that can be identified and differentiated through analysis of motion data, as included in gesture data 620 from the wearable device. Biomechanical characteristics may include, without limitation, gait patterns, posture and/or movement, gesture dynamics (e.g., a unique way an individual performs a gesture, such speed, strength, fluidity, and sequence of the gesture), muscle activation patterns, and so forth. These characteristics can be recorded and interpreted through the sensors in a wearable device and can be used to train a machine learning model to recognize and distinguish individual wearers based on these unique biomechanical patterns.

In some examples, machine learning model 544 may be pre-trained using a corpus of generic biomechanical characteristics gathered from a variety of users and/or wearers of wearable devices. In additional or alternative examples, machine learning model 544 may be customized, personalized, and/or specifically trained using gesture data gathered from a specific wearer (e.g., wearer 614). Hence, in some examples, one or more of modules 502 (e.g., authenticating module 506, determining module 508, executing module 510, etc.) may gather data representative of biomechanical characteristics of wearer 614 (e.g., wearer biomechanical characteristics data 622) and may train machine learning model 544 to identify wearer 614 based on the data representative of biomechanical characteristics of the wearer.

Authenticating module 506 may identify wearer 614 via a gesture in a variety of ways. For example, authentication data 542 may include a pre-recorded biometric profile of wearer 614. Authenticating module 506 may identify wearer 614 by inputting gesture data 620 into machine learning model 544 and determining whether an output value from machine learning model 544 is within a pre-determined identification threshold of the pre-recorded biometric profile of wearer 614.

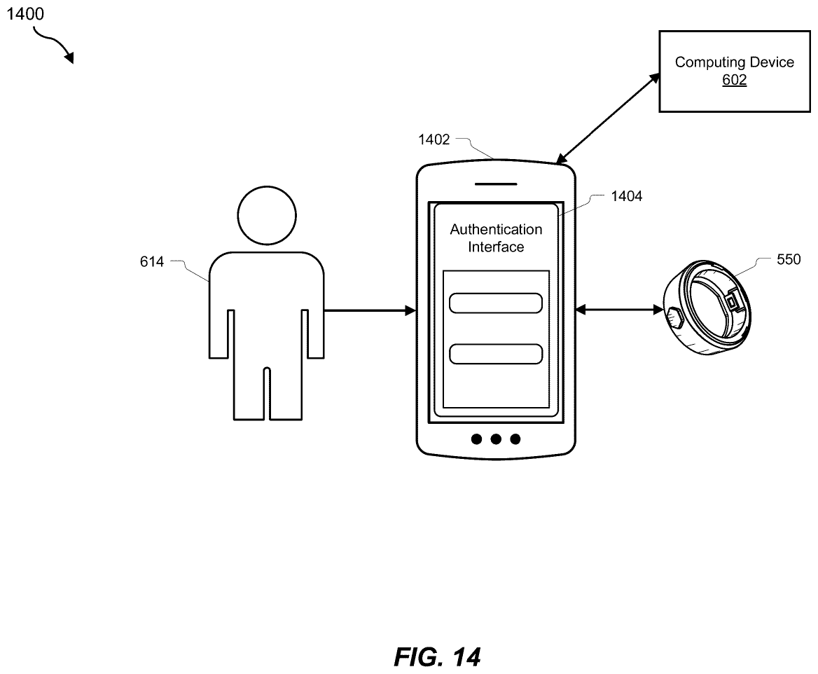

Additionally or alternatively, in some examples, authenticating module 506 may authenticate the wearer of the wearable by presenting, via a computing device communicatively coupled to the wearable, an authentication interface to the wearer. By way of illustration, FIG. 14 shows a block diagram 1400 that that illustrates authentication of a wearer of a wearable via an authentication interface. As shown, FIG. 14 includes wearable 550, computing device 602, and wearer 614. FIG. 14 also includes a computing device 1402 in communication (e.g., via a suitable data connection like data connection 604, data connection 624, etc.) with computing device 602. Computing device 1402 may include or represent any computing device that may present an authentication interface 1404 that may receive authentication information corresponding to the wearer. In some examples, one or more components included in computing device 602 may be included in or implemented by computing device 1402.

An example flow of operations may proceed in this fashion: wearer 614 may don wearable 550. Sensor 552, which may include a proximity, contact, or tactile sensor, may indicate to wearable 550 that a wearer has donned wearable 550. Wearable 550 may indicate to authenticating module 506 (e.g., via data connection 604) that a wearer has donned wearable 550. Authenticating module 506 may then authenticate the wearer using a structured continuous gesture as described above. Authenticating module 506 may additionally present authentication interface 1404 to wearer 614 via computing device 1402. Authentication interface 1404 may receive authentication information (e.g., a username, a password, a multi-factor authentication token, etc.) and may cause computing device 1402 to transmit and/or computing device 602 to receive the authentication information. Hence, authenticating module 506 may authenticate wearer 614 using multiple factors for authentication.

Once authentication is successful, the next step is authorization. “Authorization” may include any process of determining a level of access and/or permissions that the authenticated user or entity has within a computing system. Authorization may define and enforce policies related to the access and usage of resources, such as files, databases, or applications. While authentication establishes the identity, authorization deals with controlling what that identity is allowed to do, based on predefined roles, permissions, or access controls.

Hence, returning to FIG. 7, at step 730, one or more of the systems described herein may determine whether the wearer is authorized to provide the request to execute the secured action. For example, determining module 508 may, as part of computing device 602 in FIG. 6, cause computing device 602 to determine whether wearer 614 is authorized to provide request 606 to execute secured action 608.

Determining module 508 may determine whether wearer 614 is authorized to provide request 606 to execute secured action 608 in a variety of contexts. For example, determining module 508 may access authorization data 546 in data store 540. As described above, authorization data 546 may include user credentials, payment method details, access permissions, security tokens, or other related information that verifies that wearer 614 is entitled to or has capacity within the system (e.g., example system 500 and/or example system 600) to request that secured action 608 be executed.

Returning to FIG. 7, at step 740, one or more of the systems described herein may, upon authenticating the wearer and determining that the wearer is authorized to provide the request to execute the secured action, execute the secured action. For example, executing module 510 may, as part of computing device 602 in FIG. 6, cause computing device 602 to, upon authenticating module 506 authenticating wearer 614 and determining module 508 determining that wearer 614 is authorized to provide the request to execute the secured action, execute secured action 608.

In some examples, a “secured action” may include a procedural or operational action performed by a computer system or software with a purpose of ensuring safety, protection, or controlled access of a secured device. In some examples, a “secured device” may include a piece of electronic equipment that has protective measures in place to prevent unauthorized access or operation. These measures could include password protection, biometric scanning, encryption, or other security protocols. Secured devices may often be part of a network and may communicate with other devices and systems within the network. Security may be a key feature of these devices, as they may contain, control, or process sensitive or personal data, or control critical operations. Examples of secured devices may include, without limitation, financial devices (e.g., NFC terminals), smart home devices (e.g., thermostats, door locks, security cameras, etc.), smart speaker devices, smart lighting devices, smart switches, security systems, home appliances, networking devices, landscaping devices, home automation devices, entertainment devices, and so forth.

The secured nature of these devices means that they should only respond to approved commands from recognized sources or users, thus maintaining the security of the system they are part of. Hence, some embodiments of the systems and methods described herein may authenticate wearer of a wearable and may determine whether the wearer is authorized (e.g., wearer 614 of wearable 550) to interact with one or more secured devices (e.g., secured device 610).

Executing module 510 may execute a secured action in a variety of ways depending on the context and the specific security protocols in place. Some examples of secured actions may include confirming or disconfirming a financial transaction via a secured device, granting or denying access to a secured device, preventing execution of a secured action, granting or denying access to specific or limited functionalities of a secured device, generating an alert or notification for a system administrator or rightful owner of a secured device in case of an unidentified or unauthorized user, locking down a secured device in case of an unidentified or unauthorized user (e.g., to prevent a security breach), and so forth.

Hence in at least one example, executing module 510 may execute a secured action (e.g., wearer 614) by enabling wearer 614 to interact with secured device 610 in any of the ways described herein (e.g., confirming a financial transaction via secured device 610, allowing wearer 614 to interact with secured device 610, activating or deactivating secured device 610, etc.). Conversely, upon determining that wearer 614 does not have permission to interact with secured device 610, preventing the wearer from interacting with the secured device in any of the ways described herein (e.g., disconfirming a financial transaction via secured device 610, denying access to secured device 610, notifying an administrator of a failed interaction attempt, etc.).

As may be clear from the foregoing description, the systems and methods disclosed herein have many benefits over conventional options for user identification and/or user authentication and authorization. In comparison to conventional authentication technologies and/or mechanisms, the systems and methods disclosed herein may have advantages of simplicity, both in computational requirements as well as user interface. As only tactile feedback is needed, embodiments of the systems and methods disclosed herein may provide viable options for stand-alone authentication on highly restricted platforms (e.g., small form-factor smart rings or other wearables with low-power computing resources and without other conventional interfaces like touch screens, cameras, microphones, etc.). Moreover, due to the private nature of the tactile feedback, embodiments of the systems and methods disclosed herein may be far more inclusive in that they may offer significant advances in protection of disabled people (e.g., visually impaired person). Furthermore, some embodiments may not require any training data, may be easy to set up, and may present a highly intuitive and simple user experience.

Thus, the systems and methods disclosed herein may provide a simple, secure, yet user-friendly experience for user authentication and authorization. By considering multiple authentication and authorization options, including the integration of locomotive properties, structured continuous gestures, and gesture-based passwords, the disclosed systems and methods provide flexibility to tailor the approach to specific user needs and technological capabilities. The focus on user experience, particularly the desire for a seamless and secure process without reliance on additional devices, represents a significant advancement in wearable technologies.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive gesture input data to be transformed, transform the gesture input data, output a result of the transformation to identify a gesture executed by a wearer of a wearable device, use the result of the transformation to execute a security action, and store the result of the transformation to track a history of gesture input. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, from a wearable, data representative of a gesture executed by a wearer of the wearable;
recognizing, based on the data representative of the gesture, the gesture executed by the wearer;
identifying, based on the data representative of the gesture, the wearer via a machine learning model trained to identify biomechanical characteristics of wearers based on gesture data; and
executing, based on the gesture executed by the wearer and identifying of the wearer, a security action directed to a secured device.

2. The computer-implemented method of claim 1, further comprising:
gathering data representative of biomechanical characteristics of the wearer; and
training the machine learning model to identify the wearer based on the data representative of biomechanical characteristics of the wearer.

3. The computer-implemented method of claim 2, wherein:
the machine learning model comprises an autoencoder; and
training the machine learning model to identify the wearer based on the data representative of biomechanical characteristics of the wearer comprises using the autoencoder to generate, based on the data representative of biomechanical characteristics of the wearer, a wearer encoding corresponding to the wearer;
identifying, based on the data representative of the gesture, the wearer via the machine learning model comprises:
generating, from the gesture data via the autoencoder, a test encoding; and
determining that a difference between the test encoding and the wearer encoding is below a predetermined threshold.

4. The computer-implemented method of claim 1, wherein:
the wearable is included in a local controlled network; and
the computer-implemented method further comprises:
determining, based on the data representative of the gesture executed by the wearer of the wearable, that the data representative of the gesture exceeds a predetermined degree of complexity; and
transmitting the data representative of the gesture to a support system external to the local controlled network.

5. The computer-implemented method of claim 4, wherein the support system external to the local controlled network comprises at least one computing system having additional computing resources unavailable within the local controlled network and configured to at least one of:
recognize gestures based on data representative of gestures executed by wearers of wearables; and
identify wearers of wearables based on data representative of gestures executed by wearers of wearables.

6. The computer-implemented method of claim 4, wherein transmitting the data representative of the gesture to the support system external to the local controlled network comprises encrypting the data representative of the gesture within the local controlled network prior to transmitting the data representative of the gesture to the support system external to the local controlled network.

7. The computer-implemented method of claim 4, wherein:
the computer-implemented method further comprises receiving, from the support system, data representative of a recognized gesture; and
recognizing the gesture executed by the wearer is based on the data representative of the recognized gesture.

8. The computer-implemented method of claim 4, wherein:
the computer-implemented method further comprises receiving, from the support system, data representative of an identified wearer; and
identifying the wearer is further based on the data representative of the identified wearer.

9. The computer-implemented method of claim 1, wherein:
identifying the wearer comprises authenticating an identity of the wearer; and
executing the security action comprises:
determining whether the wearer has permission to interact with the secured device;
upon determining that the wearer has permission to interact with the secured device, enabling the wearer to interact with the secured device; and
upon determining that the wearer does not have permission to interact with the secured device, preventing the wearer from interacting with the secured device.

10. The computer-implemented method of claim 1, wherein the secured device comprises at least one of:
a smart home device;
a smart speaker device;
a smart lighting device;
a smart switch;
a security system;
a home appliance;
a networking device;
a landscaping device;
a home automation device; and
an entertainment device.

11. The computer-implemented method of claim 1, wherein:
the wearable comprises a near-field communication (NFC) payment device;
the secured device comprises a near-field communication (NFC) payment terminal; and
executing the security action comprises executing an NFC payment transaction between the wearable and the NFC payment terminal.

12. A computer-implemented method comprising:
receiving a request to execute a secured action with respect to a secured device;
authenticating, by recognizing a structured continuous gesture executed by a wearer of a wearable via at least one sensor included in the wearable, the wearer of the wearable;
determining whether the wearer is authorized to provide the request to execute the secured action; and
upon authenticating the wearer and determining that the wearer is authorized to provide the request to execute the secured action, executing the secured action via the secured device.

13. The computer-implemented method of claim 12, wherein:
the at least one sensor included in the wearable comprises a movement tracking sensor that tracks movement of the wearable in three-dimensional space;
authenticating the wearer of the wearable comprises:
receiving, from the movement tracking sensor, movement data associated with execution by the wearer of the structured continuous gesture; and
recognizing, based on the movement data, the structured continuous gesture executed by the wearer.

14. The computer-implemented method of claim 13, wherein recognizing, based on the movement data, the structured continuous gesture executed by the wearer comprises comparing the movement data to a predetermined control set of movement data.

15. The computer-implemented method of claim 12, wherein authenticating the wearer of the wearable further comprises:
identifying a wearer initiation of a first portion of the structured continuous gesture;
tracking, via the wearable, an execution of the first portion of the structured continuous gesture;
determining that the first portion of the structured continuous gesture has been executed; and
prompting the wearer to execute a second portion of the structured continuous gesture.

16. The computer-implemented method of claim 15, wherein determining that the first portion of the structured continuous gesture has been executed comprises:
setting a duration of time for execution of the first portion of the structured continuous gesture; and
determining that the duration of time for execution of the first portion of the structured continuous gesture has expired.

17. The computer-implemented method of claim 16, wherein setting the duration of time for execution of the first portion of the structured continuous gesture comprises setting a random duration of time as the duration of time for execution of the structured continuous gesture.

18. The computer-implemented method of claim 15, wherein prompting the wearer to execute the second portion of the structured continuous gesture comprises initiating a tactile feedback function of the wearable in response to determining that the first portion of the structured continuous gesture has been executed.

19. The computer-implemented method of claim 12, wherein authenticating the wearer of the wearable further comprises:
presenting, via a computing device communicatively coupled to the wearable, an authentication interface to the wearer; and
receiving, via the authentication interface, authentication information corresponding to the wearer.

20. The computer-implemented method of claim 12, wherein:
the secured device comprises a near-field communication (NFC) payment terminal;
receiving the request to execute the secured action with respect to the secured device comprises detecting a physical interaction between the wearable and the NFC payment terminal; and
executing the secured action comprises executing an NFC payment transaction between the wearable and the NFC payment terminal.
